(19) United States
(12) Patent Application Publication
(10) Pub. No.: US 2011/0276440 A1
(43) Pub. Date: Nov. 10, 2011

(54) System for Generating and Delivering Both Real-Time and Historical Analytic Reports for Data Captured Through Sensor Related Technology

(75) Inventors: Ketrus D. Collins, Wheeling, IL (US); Nusreth Baig, Palatine, IL (US)

(73) Assignee: LYGASE RFID SOLUTIONS, Wheeling, IL (US)

(21) Appl. No.: 13/086,129

(22) Filed: Apr. 13, 2011

Related U.S. Application Data
(60) Provisional application No. 61/323,421, filed on Apr. 13, 2010.
(60) Provisional application No. 61/332,482, filed on May 7, 2010.
(60) Provisional application No. 61/474,976, filed on Apr. 13, 2011.

(51) Int. Cl. G06Q 10/00

(52) U.S. Cl. 705/28

(57) ABSTRACT

A system and method are disclosed in which the system is a business intelligence system that captures data in real time and allows for historical and analytical reporting. The solution relies on RTLS and UHF RFID sensor technology that captures the exact x, y, and z coordinates of a particular asset, i.e., person or object and based upon the detection of a pre-encoded UHF RFID tag. The system is comprised of various components that are beneficial in order to produce reports. The system relies on hardware components such as tags and sensors that communicates and passes data to the application framework that handles data, stores data captured from sensors as events in database and Lygase using algorithms, business rules and SQL to generate meaningful real time reports.

### CROSS REFERENCE TO RELATED APPLICATIONS

The present application claims the benefit of U.S. Provisional Application No. 61/323,421, filed Apr. 13, 2010, entitled, “System for Generating and Delivering Both Real-Time and Historical Analytic Reports for Data Captured Through Sensor Related Technology”, U.S. Provisional Application No. 61/332,482, filed May 7, 2010, entitled, “System for Generating and Delivering Both Real-Time and Historical Analytic Reports for Data Captured Through Sensor Related Technology”, and U.S. Provisional Application No. 61/474,976, filed Apr. 13, 2011, entitled, “System for Generating and Delivering Both Real-Time and Historical Analytic Reports for Data Captured Through Sensor Related Technology”, all of which are herein incorporated by reference.

### BACKGROUND

The present system relates to the field of Business Intelligence and the use of UHF RFID and other sensor related technology. Specifically, the present system relates to the reporting on assets of interest identified by UHF RFID and or other sensor related technology within a space of interest. In an embodiment assets of interests can be: (i) People attending a trade show, and space of interest is trade show exhibit hall and meeting rooms; (ii) shopping carts, and space of interest is retail stores; (iii) patients, medical equipment, devices, and space of interest is healthcare facility; (iv) Hardware, furniture, cables, and space of interest is commercial property; (v) Automobiles, and space of interest is auto dealerships; and (vi) Students, equipment, computers, and space of interest is schools.

### SUMMARY

The present system, known as the SmartShows™ system, is a business intelligence system that captures data in real time and allows for historical and analytical reporting. The SmartShows™ solution relies on RTLS and UHF RFID sensor technology that captures the exact x, y, and z coordinates of a particular asset i.e. person or object and based upon the detection of a pre-encoded UHF RFID tag. The system is comprised of various components that are beneficial in order for the Lygase SmartShows™ application to produce reports. The system relies on hardware components such as tags and sensors that communicates and passes data to the application framework that handles data, stores data captured from sensors as events in database and Lygase using algorithms, business rules and SQL to generate meaningful real time reports.

Other objects, features and advantages of the present system will be apparent from the accompanying drawings and from the detailed description.

### BRIEF DESCRIPTION OF THE DRAWINGS

FIG. 1 illustrates a UHF passive Real-time location tracking system (RTLS) in which the present system relies on to capture data about a particular tagged asset of interest, in a space of interest.

FIG. 2 illustrates the application framework platform (Edgeware) which is a configurable enterprise solution which allows for connectivity to any sensory devices including RTLS, RFID (Active/Passive), GPS, UWB, WiFi and more. This framework is a responsible for real-time data acquisition and logic processing locally, managing location and track and trace activities within ecosystem. The framework allows the system to associate tag id's to assets and their business attributes, automates business processes, manages local activity and allow for the creation of dashboards, and various real-time and historical reports.

FIG. 3 illustrates the three main components of the SmartShows™ system; hardware, application framework, and the SmartShows™ business intelligence layer that generates real-time and historical reports.

FIG. 3B illustrates the major components of the SmartShows™ business layer. The system must first receive asset info, the tags assigned to assets must be encoded, must receive mapping rules, determine asset location, attach time stamp, calculate score, store location data (real-time, aggregate, historical), present data via monitor, kiosk, digital signage or other media depending on business case.

FIG. 4 illustrates the ability to create unique client accounts containing customized reports based on specific business need.

FIG. 5 illustrates how the SmartShows™ systems uses the flex user interface which makes it possible to upload a floor plan to the system and calibrate the floor plans start and end points so that they can be communicated to the RTLS system.

FIG. 6 illustrates how the user plots the starting X,Y co-ordinates and an ending X,Y co-ordinates of space of interest.

FIG. 7 illustrates the ability to define and calibrate a sub-location of interest.

FIG. 8 illustrates the ability to create various regions within the floor plan of interest. The user must define X,Y start and end points for each region.

FIG. 9 illustrates the ability to define an organizational structure and create reports of interest depending on business owner.

FIG. 9 B illustrates the ability to define sub-location or regions on floor plan so that the SmartShows™ system can determine how long asset associated with a tag has dwelled in a particular region.

FIG. 10 illustrates the SmartShows™ ability to associate a tag id to a registered asset in order to determine where an asset has traveled over the course of time.

FIG. 11 illustrates how the RTLS systems reports tag id and X,Y,Z location coordinates to the application framework where data captured is cleaned up, formatted, business logic applied and entered into system database and stored as an event.

FIG. 12 illustrates the ability to use traditional fixed point RFID readers to do automated attendance tracking.

FIG. 13 illustrates the SmartShows™ application ability to locate and describe the physical attributes of an asset in relation to the floor plan so that the user can understand the traffic patterns.

FIG. 14 illustrates the SmartShows™ application ability to provide attendee behavior analysis. Data can be used determine suggested paths, products, services or regions of interest, all driven from the data collected during the registration process.

FIG. 15 illustrates the ability for the SmartShows™ system leverage the data collected during the registration process from an attendee, to determine the category of interest and the target audience the attendee belongs to and based upon that information the system is able to deliver targeted message.

FIG. 16 illustrates the primary tables used in the SmartShows™ application from which all business intelligence reports stated as part of this application are derived.

FIG. 17 illustrates the various types of reports that SmartShows™ application is able to deliver.

FIG. 18 illustrates how data get persisted to the user interface of the SmartShows™ systems.

FIG. 19 illustrates the SmartShows™ Visitor Tracker report that displays the total number of booths, visitors per booth and their details & location on the show floor.

FIG. 20 illustrates the SmartShows™ Visitors by Industry report that displays a pie-chart representation of the industries that the attendees seen on floor plan belong to.

FIG. 21 illustrates the breakdown of the SmartShows™ pie-chart based on the selection of a particular industry.

FIG. 22 illustrates the SmartShows™ Top ten booths report which is a pie-chart representation of the top 10 booths at the show based on the number of assets or attendees present.

FIG. 23 illustrates the SmartShows™ real-time Bubble map report of booth population in the form of expanding and contracting bubbles.

FIG. 24 illustrates a SmartShows™ Live Dashboard report that has the ability to display in real time location of a particular asset of interest based on asset type.

FIG. 25 illustrates the SmartShows™ Visitors List report that list of total number of assets where assets are attendees and their history as they moved about the space of interest.

FIG. 26 illustrates the SmartShows™ Density Map which has ability to report real-time density of population at various locations across the show floor based on time.

FIG. 27 illustrates SmartShows™ Overall Show Statistic reports ability to display statistics regarding asset's number of visits and average dwell time in areas of interest. Data can be sliced and diced across type of attendee, Exhibitor, Title, booth size day of the show and time of the show.

FIG. 28 illustrates SmartShows™ Averages report based on the history of tagged assets moving in space of interest.

FIG. 29 illustrates SmartShows™ ability to display a report based on an attendees dwell time (217) at various locations at the Exhibit.

FIG. 30 illustrates SmartShows™ ability to issue continuing education units (CEU), verify attendance and calculate dwell time of attendees seen as they enter and exit meeting and conference room areas (see related application section entitled Instructions for attendance monitoring of CEUEvent and CEU application code, CEU snapshots);

FIG. 31 illustrates SmartShows™ ability to generate an automated Leads Report which contains Lead ranking and dwell time.

FIG. 32 illustrates SmartShows™ ability to generate the exhibitors Target Audience report out the total number of attendees seen on the exhibition show floor.

FIG. 33 illustrates SmartShows™ ability to generate a Competitive Analysis report that displays the information of those attendees that visited an exhibitor's booth and also visited their competitor's booth.

FIG. 34 illustrates SmartShows™ the ability to generate Over All Statistics report regarding asset's number of visits and average dwell time in areas of interest. Data can be sliced and diced across time and date, asset description.

FIG. 35 illustrates SmartShows™ ability to understand traffic patterns of assets as they move around in a space of interest based on certain criteria. Patterns of behavior are gleaned from looking at average/maximum dwell time, and number of visits to space of interest.

FIG. 36 illustrates the ability to provide user a web interface that contains marketing material from all regions or locations that a tagged asset was seen from which a user can download or email to oneself.

FIG. 37 illustrates the attendee's ability to opt-in or opt-out of the automated lead retrieval system.

### DETAILED DESCRIPTION

The present system relates to a method and apparatus for creating meaningful reports related to assets of interest moving around in a space of interest. This system relates to business intelligence and method and apparatus for data analysis activity based the movement of a particular. asset. Currently there does not exist an automated, UHF passive solution for understanding traffic patterns, behavior and dwell time for a particular space of interest. In the following detailed description, numerous specific details are set forth in order to provide a thorough understanding of the present system. It will be apparent to one of the ordinary skill in the art, however, that these specific details need not be used to practice the present system. In other instances, well-known structures, interfaces and processes have not been shown in detail in order not to unnecessarily obscure the present system.

The present system describes the process for augmenting location based services such as understanding how many people spent time around certain products or assets of a certain type. This may include placing kiosk, games, signs, digital signage, throughout a trade show. In a conference, the SmartShows™ system may be employed to confirm attendance at one or more sessions or presentations. The system can also be used to determine average stay at a particular presentation. Other data may also be obtained such as most popular presentations. The system could be employed to track interest in presentations. This may include, for example number off attendees at a general session and one or more targeted sessions, along with the duration of attendance and the like.

In one embodiment the location based attendees' data may be used to support location based advertising. Tradeshows typically sell sponsorship which may be realized as signage and kiosk displays. These may contain show specific information (e.g., visit company x at booth ABC) or more general product, service of marketing information. The SmartShows™ system can provide a suggested path and provide incremental suggestions based on tag id read. The system can identify the history of booths attended, determine product interest and suggest booths that are nearby.

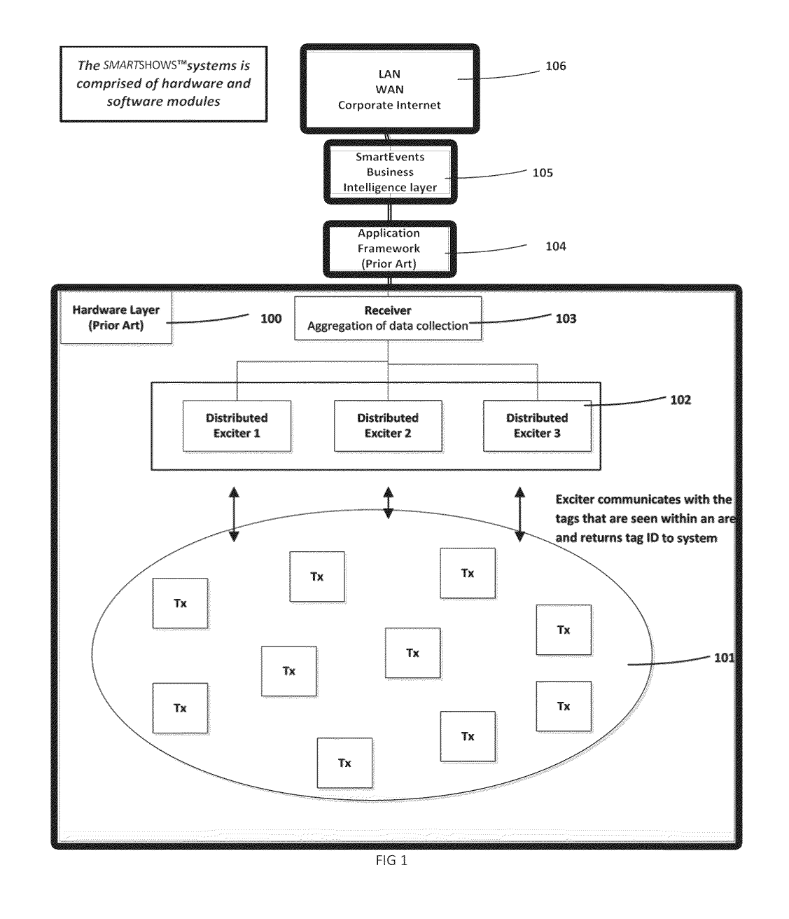

The dynamic signage may use a number of algorithms to determine appropriate message. The signage may rotate a number of different displays for a particular advertiser, sponsor, or the like. Or the signage may rotate displays for different advertisers based on determined profile. FIG. 1 illustrates a passive real-time location system (RTLS) which the present system relies on to capture data about a particular tagged asset of interest, in a space of interest. The preferred embodiment of the present system relies on the data captured by the RTLS system. An alternate embodiment may be implemented using other sensor technology.

In general, such hardware systems as illustrated in FIG. 1 comprise of Local Area Network (LAN) which can utilize corporate network or Wide Area Network (WAN) (106) to communicate location data received from tags (101) captured through sensor devices (102) and send data packets directly to receiver/controller (103). Location reporting may occur at period intervals (e.g., every five seconds, every five minutes, etc) set in a parameters file (see related patent application section entitled Sensor net Device Configuration Parameter Definitions).

The master controller creates and pushes a XML packages containing X, Y, Z coordinates of all tags seen to the middleware layer of the SmartShows™ system known as the application framework (104) upon which the upon which the application resides (see related application section entitled xml data packet from RTLS system).

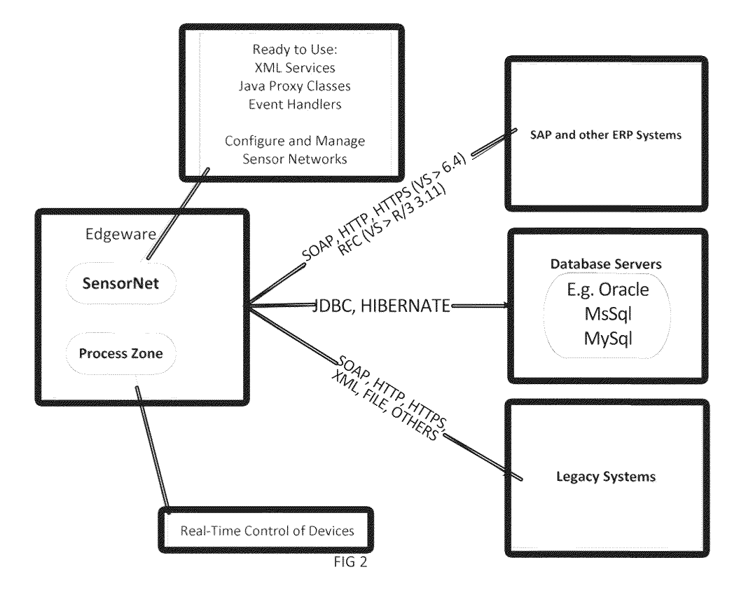

FIG. 2 illustrates the Edgeware Software Platform (aka application framework) which is a configurable enterprise solution which makes it possible to develop many types of solutions business intelligence solutions for many industry verticals. The application framework is hardware agnostic and allows for connectivity and data capture from many sensory devices including RFID (Active/Passive), GPS, UWB, Wi-Fi, mobile and more. This framework is a responsible for real time data acquisition and logic processing locally, managing location and track and trace activities within ecosystem, initiate, associate sensory technologies to assets. The framework allows the system to associate business attributes from enterprise systems to assets, manages local activity and processes and allow for the creation of dashboard views for processes, KPI management, and automation.

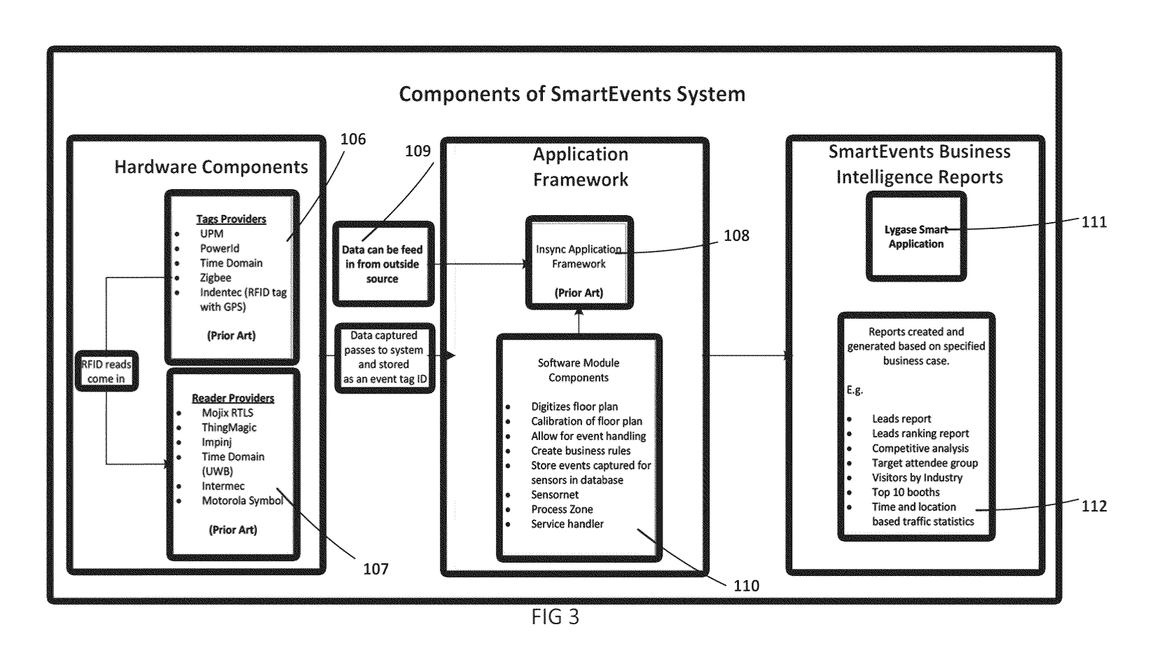

FIG. 3 illustrates the three main components of a complete system that embodies the present system. These components are hardware component (100), application framework (104), and the SmartShows™ business intelligence layer (105) which is the core of the present system. One major component of the hardware systems is the tags (106). The tags make it possible to associate an ID with an asset. Tags become excited through RFID sensor technology (107). In one embodiment the sensor technology of choice is RTLS which can return the actual X, Y, Z coordinates of a tag. While another embodiment can utilize traditional readers when trying to understand if a tag is within a particular zone. In either case the tag ID captured passes to the application framework (108) and stored as an event. Data can also be fed into the application framework through an outside source (109). In one embodiment an outside source can be registration data from a third party system (see related application section entitled Step for Associating UHF RFID Tag ID to asset). The application framework is a configurable enterprise solution capable of many types of solutions. The framework comes equipped with functionality that allows for digitizing and calibration of floor plans, event handling, enforcing of business rules, storing of events into database, and service handling (110). The present system leverages the hardware components and functionalities that exist within the application framework to create a business intelligence reporting tool that is specific to business case tracking assets of interest on a tradeshow floor (111) The reports that are specific to this business case include leads reports, leads ranking, competitive analysis, target audience, time and location based traffic statistics (112)

FIG. 3B illustrates the major components of the SmartShows™ business layer. The system must first receive asset info, the tags assigned to assets must be encoded, must receive mapping rules, determine asset location, attach time stamp, calculate score, store location data (real-time, aggregate, historical), present data via monitor, kiosk, digital signage or other mean according to business rules in order to generate reports.

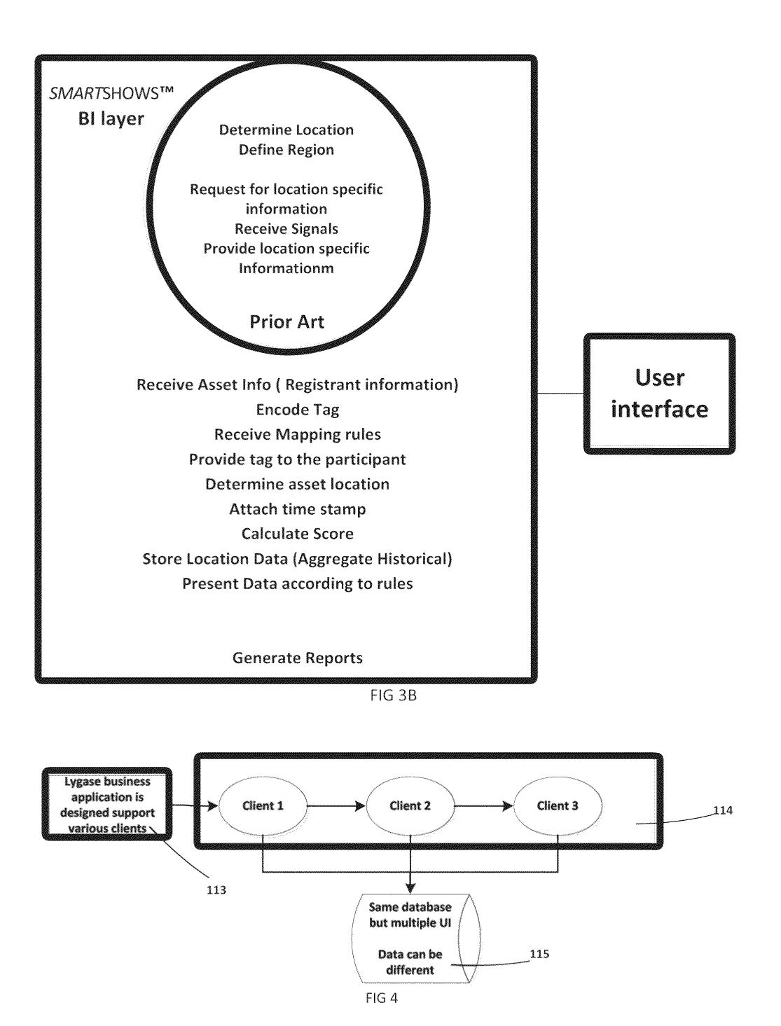

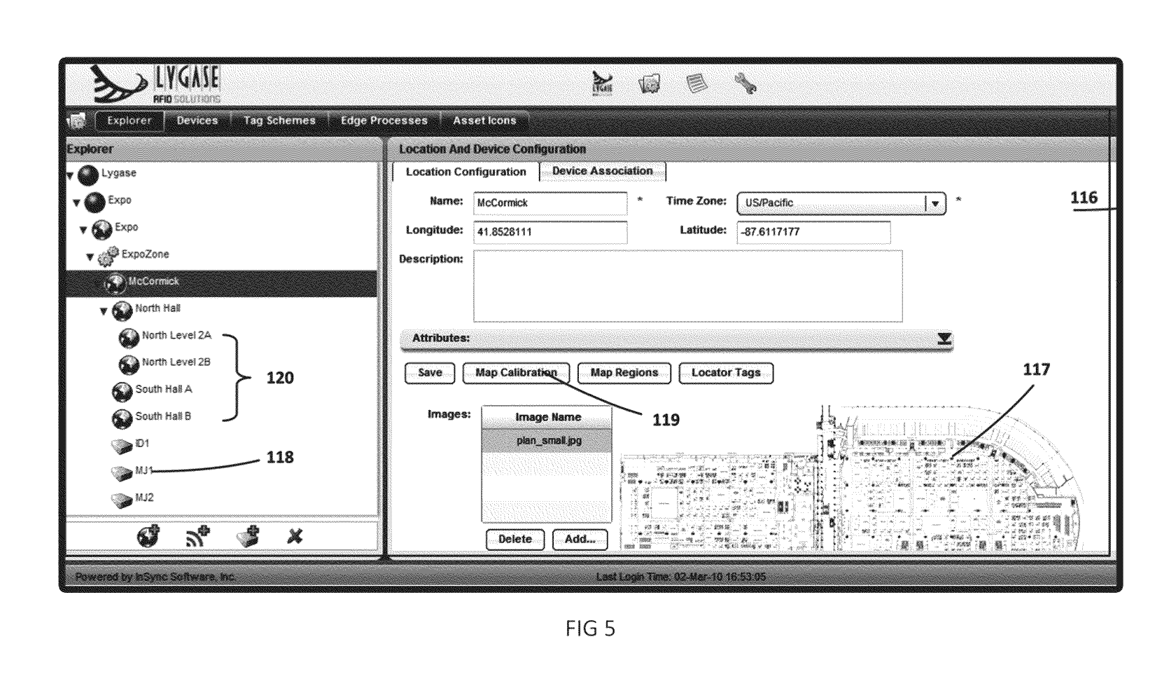

FIG. 4 illustrates the ability to create unique client accounts containing customized reports based on specific business need (113). Common reports can be shared across each client or customized according to specific needs and request (114). Data is uniquely identified by a unique Organization key which makes it possible for the same database tables to be shared across all Organizations (115).

SmartShows™ System Allows for the Display in Real Time Locations of Participants at Trade Shows or Other Venues.

FIG. 5 illustrates how SmartShows™ systems uses the Flex Ul (116) which allows a user to upload a floor plan to the system (117) and calibrate the floor plans start and end points so that those co-ordinates may be communicated to the actual RTLS system (118). Once the image has been uploaded it is calibrated using the Location Configuration and Map calibration controls (119) of the user interface.

If the overall floor-plan is thought of as a “Location”, the system can be configured in such a way that it includes many “Sub-locations” which can be further drilled-down to the “Region”. The system can track movement in any region created or predetermined specified areas on the floor plan. These zones are known as regions (120). Regions in the SmartShows™ application are known as exhibitor booths. In another embodiment regions can be departments or aisles within a retail space.

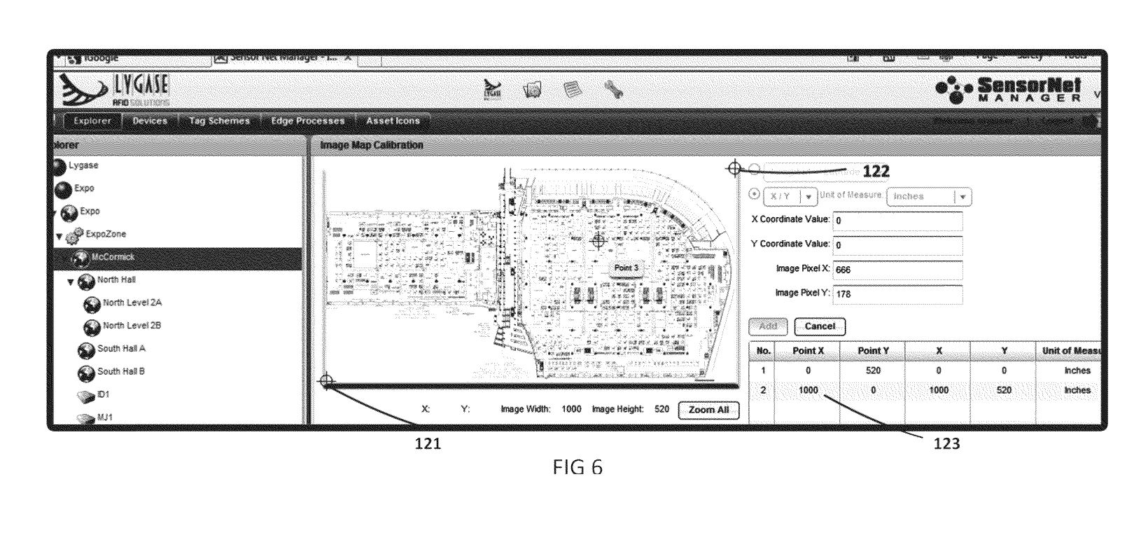

FIG. 6 illustrates how the system plots the starting X, Y (121) co-ordinates and an ending X, Y (122) co- ordinates of space of interest. Every sub-location under this image can have the exact same image as their region or parts of the initial image defined as a region. In this illustration, the X coordinate starts at zero but the Y coordinate starts with an offset (123).

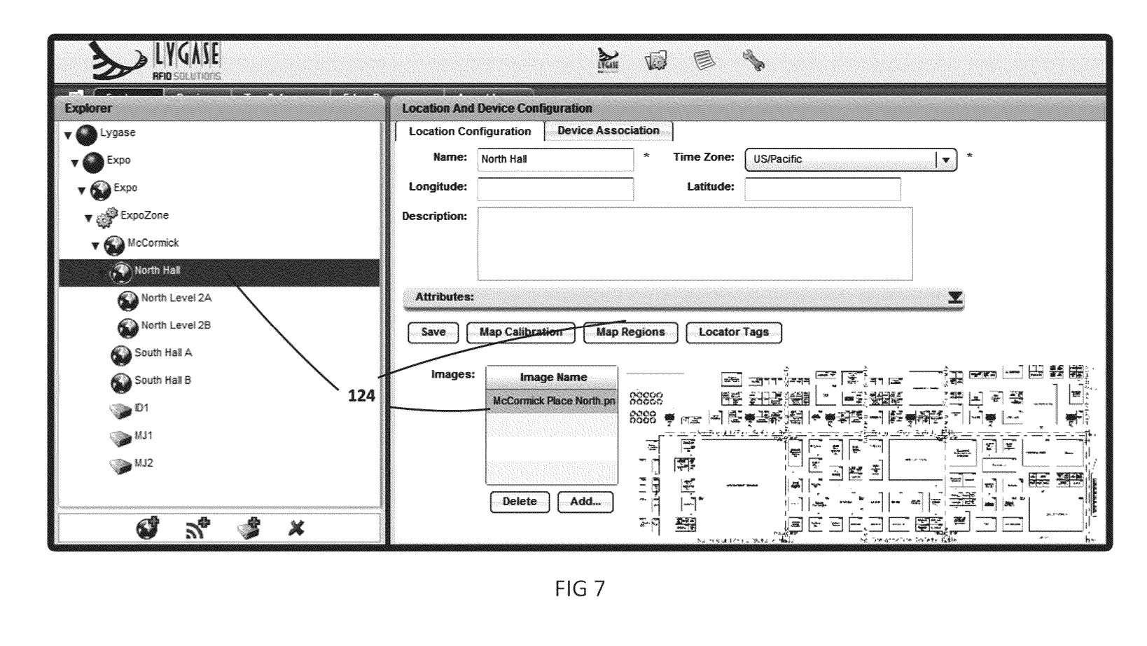

FIG. 7 illustrates the ability to define and calibrate a sub-location of interest. When there are multiple zoom-in capabilities, the top-most image lies on top of the primary image. In FIG. 5 McCormick is the top- most image. In the example below the North Hall is defined as a sub-location (124). Each separate drill-down will be created as a separate sub-location after defining the start and end of the area of interest.

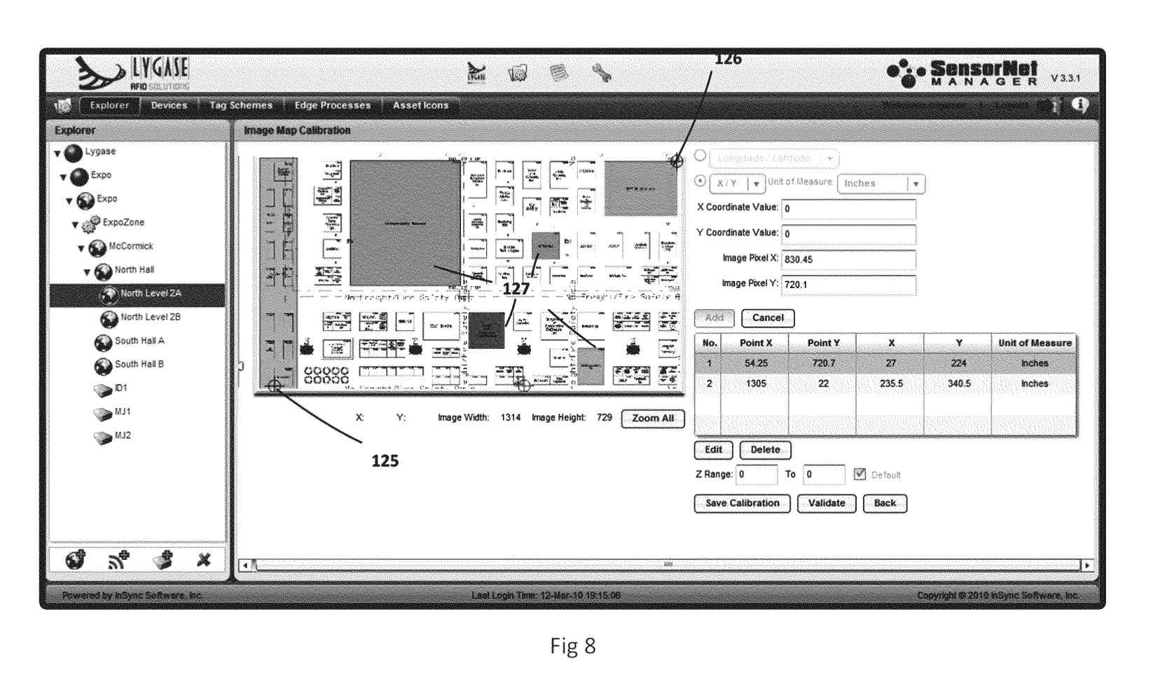

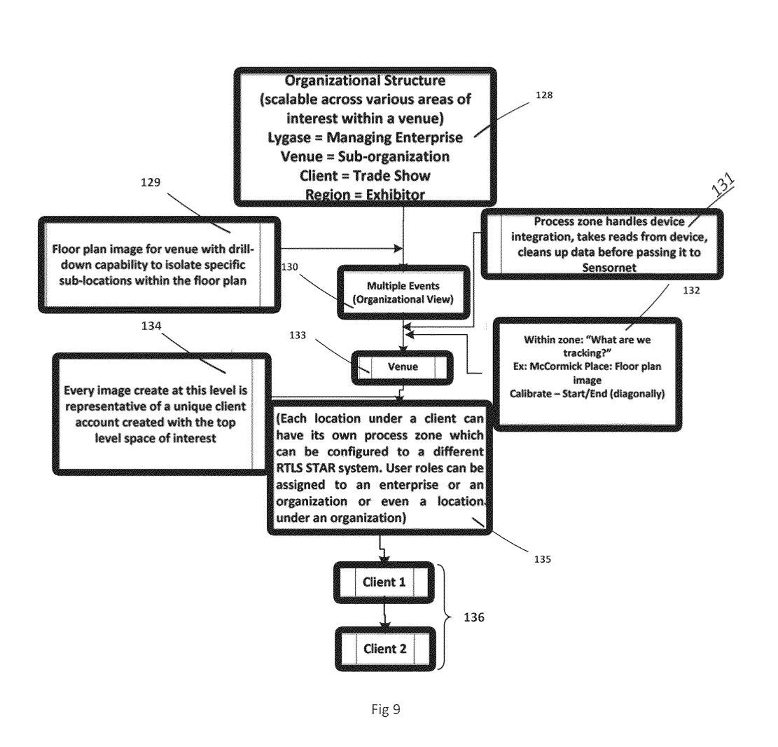

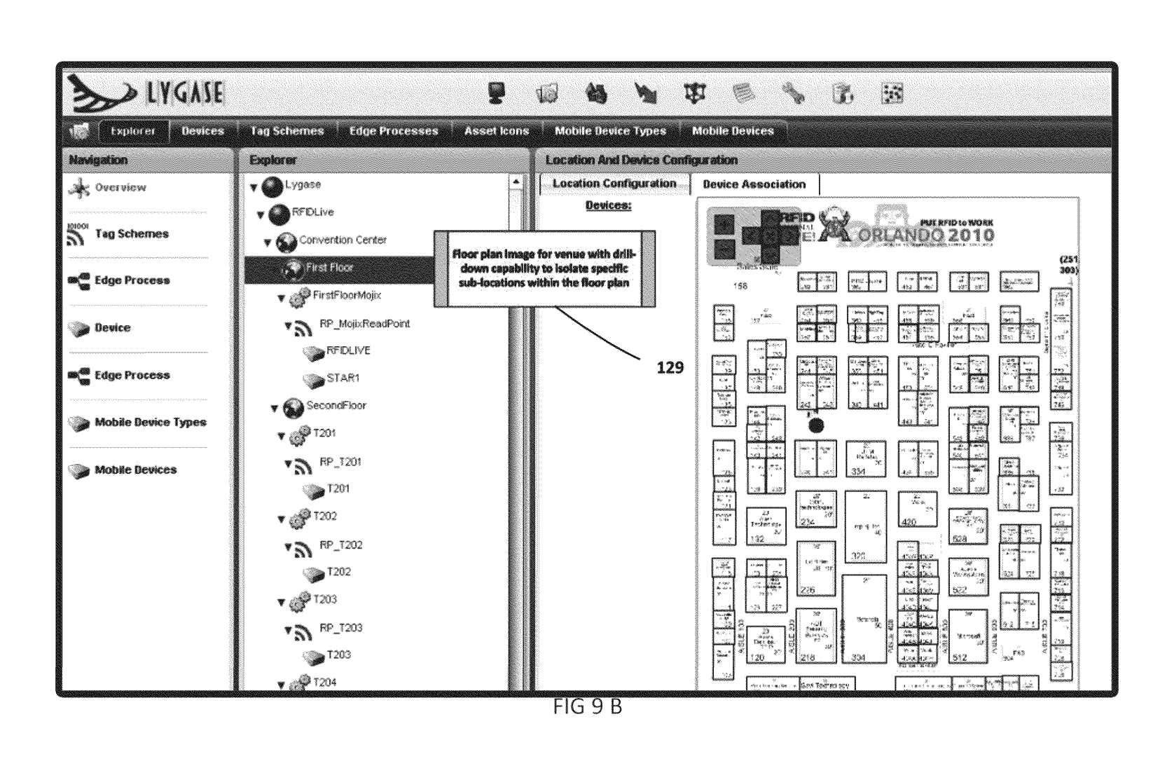

FIG. 8 illustrates the ability to create various regions within the floor plan of interest. The user must define X, Y start (125) and end points (126) for each region. Once all the required drill-downs are defined, various “regions” within these drill-down views are created (127). These regions are the individual exhibitor booths. Each of these regions/booths have their own generic attributes (such as industry, product category etc.) which can be defined separately. In one embodiment a booth is assigned a category for the purposes of determining suggested booths based on attendee category of interest. FIG 9 illustrates the ability to define an organizational structure and create reports of interest depending on business owner. In one embodiment the solution is scalable across the managing enterprise, sub organization known as venue, client who is known as Trade Show Organizer, and region of interest is the exhibitor (128). The application framework has the built in capability to upload a floor plan and create sub-locations within the floor, plan (129, see FIG. 9B). Different views are created per organization (130). The application framework uses the Process Zone which is responsible for taking reads from sensor devices and passing it to Sensor net (131). Across the various zones that have been defined, the user can understand assets or human behavior as they move around in the space of interest (132). In one embodiment the space of interest is a venue (i.e., section of building e.g. Concourse A or B, specific levels of building) (133) and every image created at this level represents a unique client account created (134). Each location under a client can have its own process zone which can be configured to a different RTLS system or other sensor devices (i.e., traditional fixed readers). User roles can be assigned to an enterprise or an organization or even a location under an organization (135). Many clients/Organizations can reside at this level (136).

FIG. 9 B illustrates the ability to define sub-location or regions on floor plan so that the SmartShows™ system can determine how long an asset/human associated with a tag has dwelled in a particular region. For each region defined (129) coordinates needs to passed from the RTLS system so that we understand what hardware device picked up signals for tags seen in a particular area of interest (see related patent application section entitled RTLS hardware configuration steps).

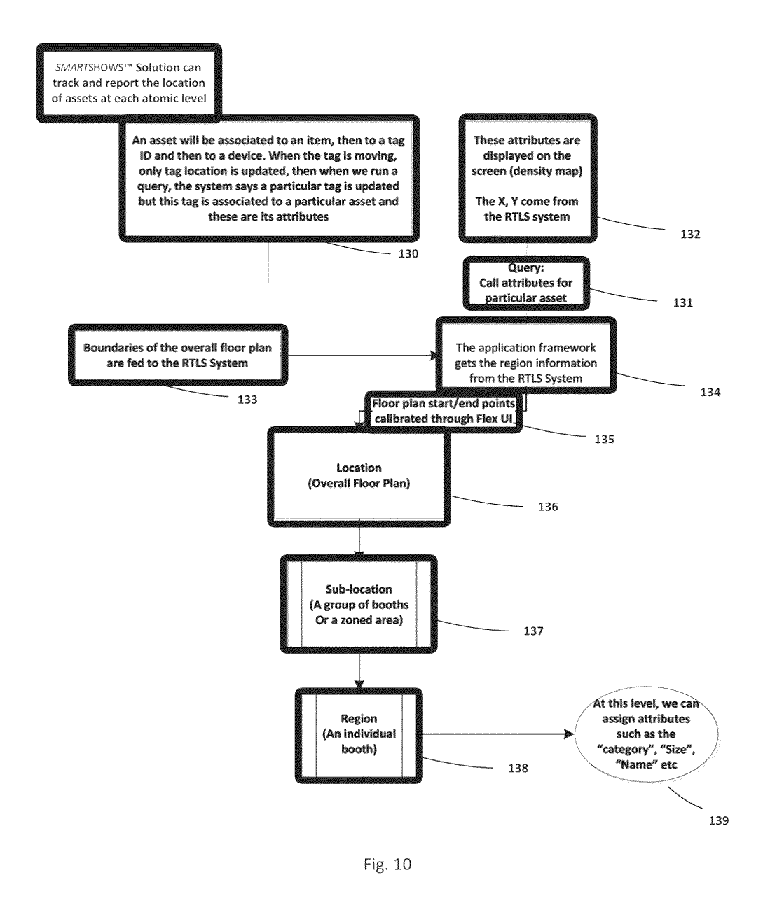

FIG. 10 illustrates the SmartShows™ ability to associate any asset or person of interest along with tag id to determine where the asset has traveled over the course of time. As the tags moves about the space of interest only tag location is updated (130) to the SmartShows™ system. A SQL call or query is made to database where attributes are associated to asset (131). These attributes are then displayed to monitor, mobile device or screen (132). Boundaries for the overall floor are fed to the RTLS System which (133) then passes region data along to application framework (134). Through the application frameworks' Flex Ul, start/end points are calibrated (135) so that the SmartShows™ system can determine the location of any asset on floor plan (136). The floor plan can be further broken down into more granular sub sections locations (137). In one embodiment, the regions are known as booths (138). At this level booths may have different sizes and or shapes with fees charged to exhibitor according to size, shape, location and any other suitable parameters (139).

The SmartShows™ application generates a lead report containing dwell time of asset of interest in space of interest.

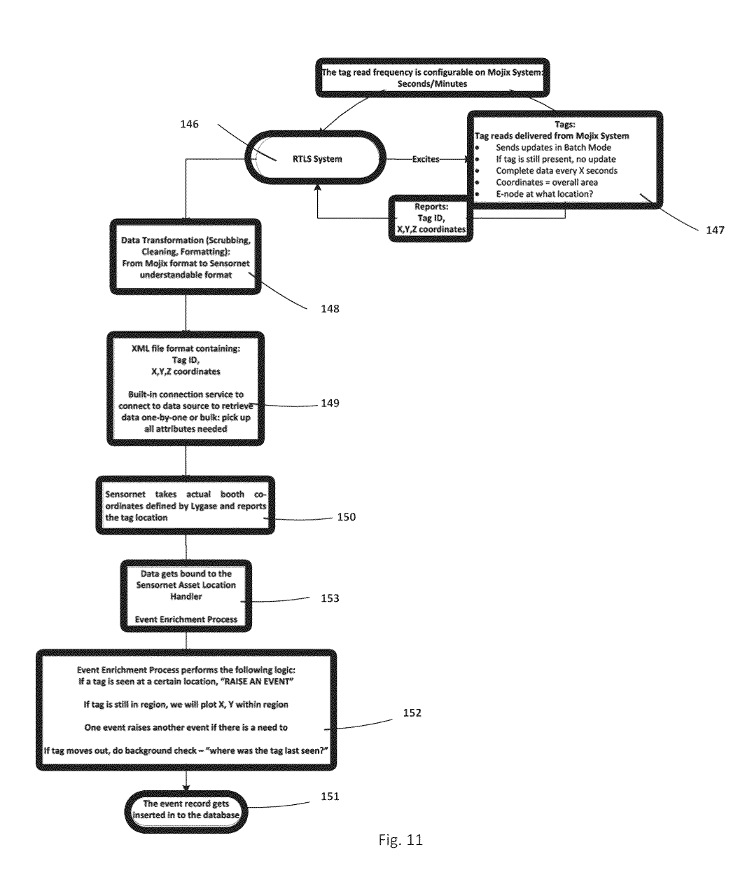

FIG. 11 illustrates how the RTLS systems reports tag id and X,Y,Z location coordinates to the application framework where data captured is cleaned up, formatted, business logic applied and entered into the systems database and stored as an event.

SmartShows™ solution relies on the RTLS system (146) or the traditional UHF readers to excite the UHF RFID tag issued to an asset. In one embodiment the RTLS system, upon the recognition of the location of the UHF RFID tag can report the actual tag ID and the actual X, Y, Z co-ordinates (147). Data is passed from the RTLS system or traditional fixed point readers to the SmartShows™ system where data transformation occurs (148). It is important for data to be delivered in a format that Sensor net can understand (149). Data received is now tied to attribute information that resides within the SmartShows™ database (150). There is an event enrichment process that is responsible for controlling the business logic such as “where was the tag last seen”, before inserting the record into the database and recording as an event (151).

When the RTLS system records a read within a sub-location/region, the system checks if the tag-read is for the first time? Or was the tag already here the last time it was seen? If it is seen for the first time, the tag has “Entered” the sub-location/region and if it was here already, the read is not even processed. This is all part of the “Event-Enrichment process” (152). In this process, if a tag read comes in, the system resolves it to see from which region it comes in. If the tag was last seen in region A and now its seen in region B, two alerts are raised, one “Exit” alert in region A and another “Entry” alert in region B. Once an “Exit” alert is generated for a region, the dwell time is calculated.

When RTLS system sends a read, it sends four parameters (e.g., tag ID, X-coordinate, Y-coordinate and Z-coordinate). Z-coordinate is ignored in this case. When a read is sent by the RTLS system, it comes into the process zone, gets forwarded to the Sensor net which has an “Asset-location Handler”. The asset location handler recognizes the exact X-Y coordinate from where the read is coming and then translates it to the region the coordinates fall under (153). The system then calculates the area of that particular region and then checks which region the read is being reported from. This gives the exact location of the tag at that point of time. Then a background check is performed to see where the tag was last seen. If the tag is still in the same region as it was last seen, no alert is raised but the X-Y coordinates are still updated to reflect the latest location. If the tag is out of the previous- region, an “Exit” alert is raised and dwell time is calculated for that particular region. All this is event- driven. One event raises the other event, if there is a need to.

SmartShows™ provides solution for automated attendance tracking using fixed point traditional readers.

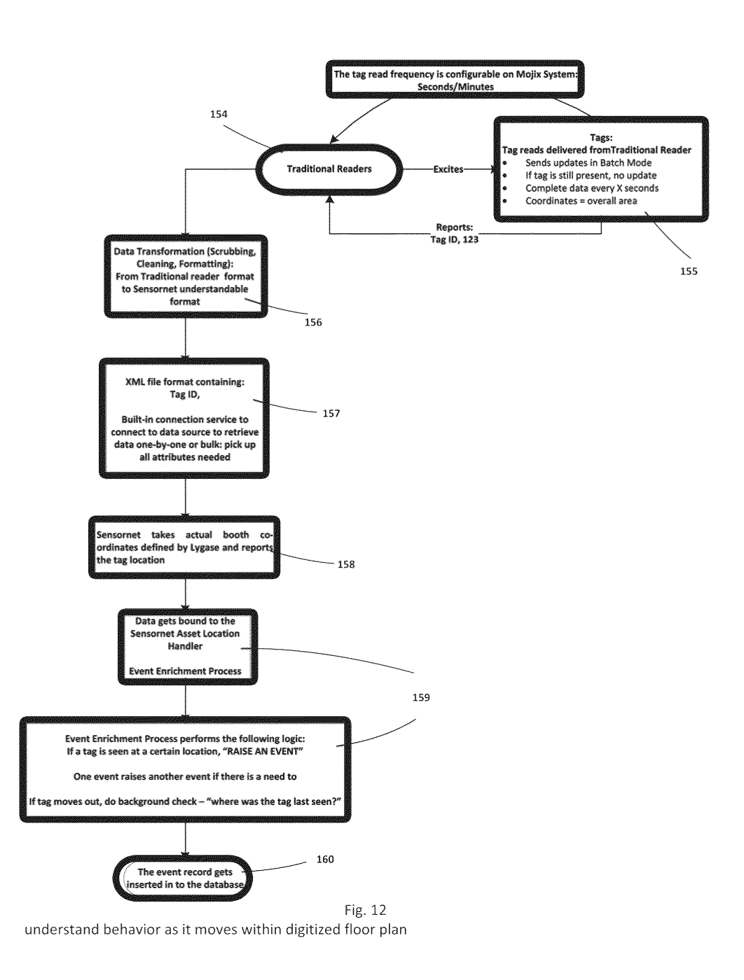

FIG. 12 illustrates the ability to use fixed point readers to do automated attendance tracking, calculate dwell time and issues CEU credits using fixed point traditional readers (154). Fixed point traditional readers are incapable of determining X,Y coordinates. In one embodiment where the system utilizes traditional readers, tags (155) excited return the tag ID (e.g. “I am here—Tag 123”). Data passed from the traditional readers enters the SmartShows™ system where data transformation occurs and prepared for entry into the SmartShows™ database (156). It is important for data to be delivered in a format that Sensor net application framework can understand (157). Data received is now tied to attribute information that resides within the SmartShows™ systems (158). There is an Event enrichment process (159) that is responsible for controlling the business logic such as “where was the tag last seen”, before inserting the record into the database and recording as an event (160). An asset of interest is read when entering a conference room, an entrance door way etc. The traditional readers excite the tag and the tag responds back to the reader “Tag ID-123”(140).

SmartShows™ uses pre-determined physical attributes regarding assets for the purpose of understanding behavior as it moves. Movement can be witnessed in real time within digitized floor plan

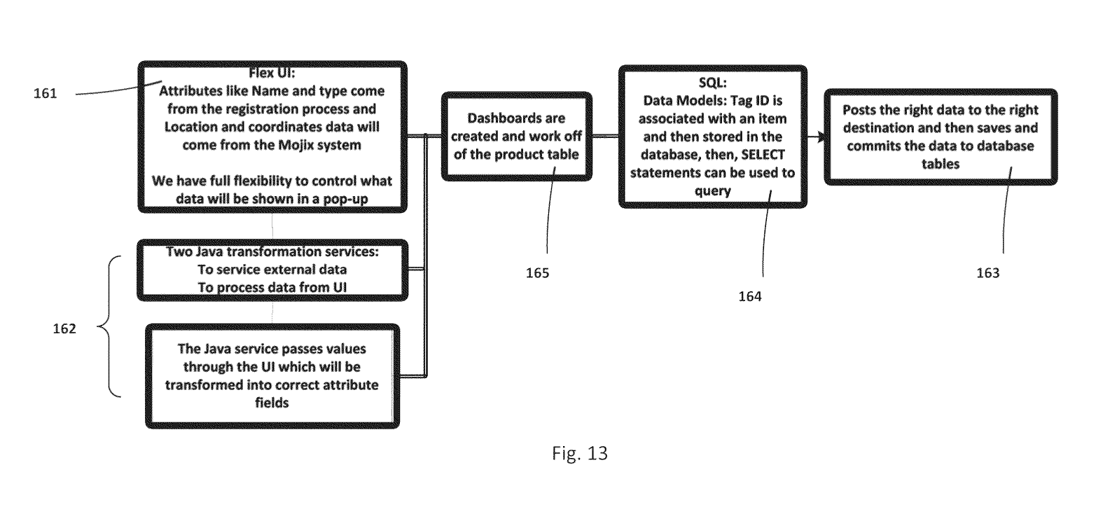

FIG. 13 illustrates the ability to associate physical attributes of an asset in relation to the floor plan so that the SmartShows™ application can deliver customized reports regarding the behavior of the asset. In one embodiment this happens as a result of the data captured though a registration process where information is gathered about a asset of interest and associated with the tag id.

Lygase SmartShows™ application screens must be customized for each client based upon its understanding of assets needing to be tracked and the reports the client is interested in receiving about the assets of interest. Customizations are made at the Flex level (161). The imaging component built into the application framework has the capability to load all the drill-down features, assets and their attributes.

The process for understanding information about a tagged asset and the ability to report information is handled through Sensor net which has a finite data model where it has generic columns in the CT_TRACKABLE_ITEM_TABLE to capture registration data/attributes for each track-able item of type string, date etc. The standard registration screen natively calls on a java service in the background (162). This screen passes certain parameters to the java service and thru that service data can be configured in such a way that the First Name field hits attribute 1 and Last name hits attribute 2 and tag ID hits the Tag ID field (163). The user defines which data attributes from the registration process hits which column in the data model. Once the tag ID gets associated to appropriate item, it becomes a matter of representing it by using a SQL query (164). The dashboards are all working on top of product tables (165). The data that is shown for each asset on the live dashboard is actually collected during registration and then associated to the asset ID. If the user wants to see the asset's full name in the pop-up on the live dashboard, he needs to customize it in such a way that the attribute-fields for the first name and last name are joined and displayed as a concatenated list.

The SmartShows™ application can analyze any particular asset pattern of behavior. Data can be used determine dwell time and chronological history report of location, how long, and when did a particular asset move in relation to floor plan.

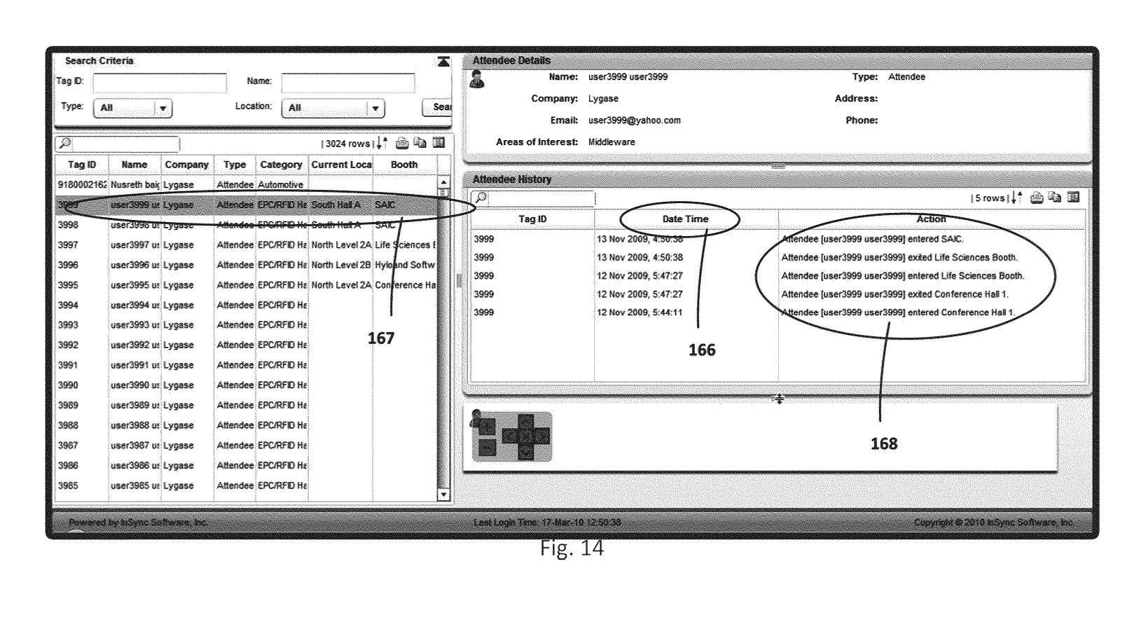

FIG. 14 illustrates the SmartShows™ application ability to produce attendee behavior analysis reports. Data can be used determine dwell time (166) and chronological history report of location, how long, and when did a particular asset (167) move in relation to floor plan. The SmartShows™ system is able to provide a visual play back that displays where an asset is moved over time (168).

SmartShows™ applications can leverage data learned about asset of interest to create and deliver personalized messages while moving around in space of interest.

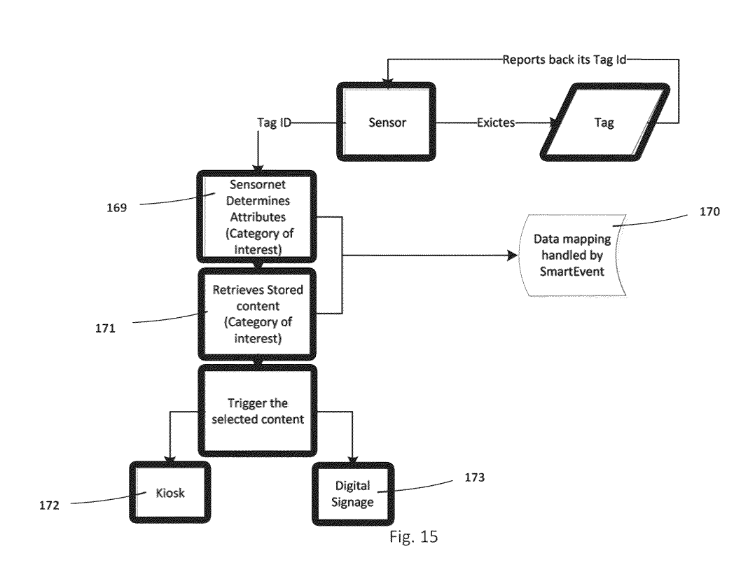

FIG. 15 illustrates the ability for the SmartShows™ system to leverage the data collected about a particular asset of interest (169) in order to pre-determine the asset category of interest so as to be able to send an a attendee (170) a targeted message (171). Data can be used determine suggested paths, products, services or regions of interest, all driven from the data collected during the registration process. Both Kiosk (172) and digital signage (173) can be used with the system to deliver the data. For example a person attending a tradeshow related to automobiles may have suggested during registration that he/she were interested in mid-size cars. When an attendee who is interested in mid-size cars approaches a kiosk or a digital signage, the system can display booth location having mid-size cars on display.

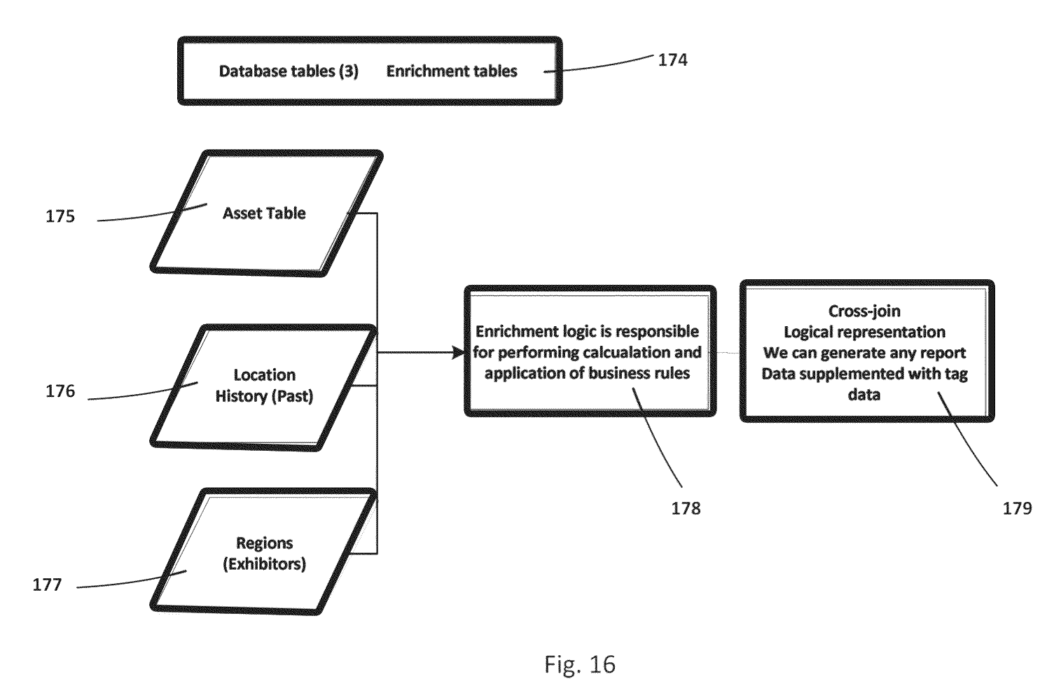

FIG. 16 illustrates the primary tables used in the SmartShows™ application from which all business intelligence reports developed as part of this application are derived. There are 3 basic tables which get populated with the data that's coming in (174). The asset table (175) stores data related to asset, the location table (176) stores history regarding the movement of a particular asset, and the regions table (177) defines the area of interest for which a tag can be seen. Then it gets deciphered and the enrichment logic figures out if the tag has moved in or moved out, raise and handle the alerts, determine whether the dwell-time needs to be calculated or not etc. (178). Then, the data is available across 3 different tables as shown below. By doing a cross-join across these tables, the system can generate various meaningful reports (179).

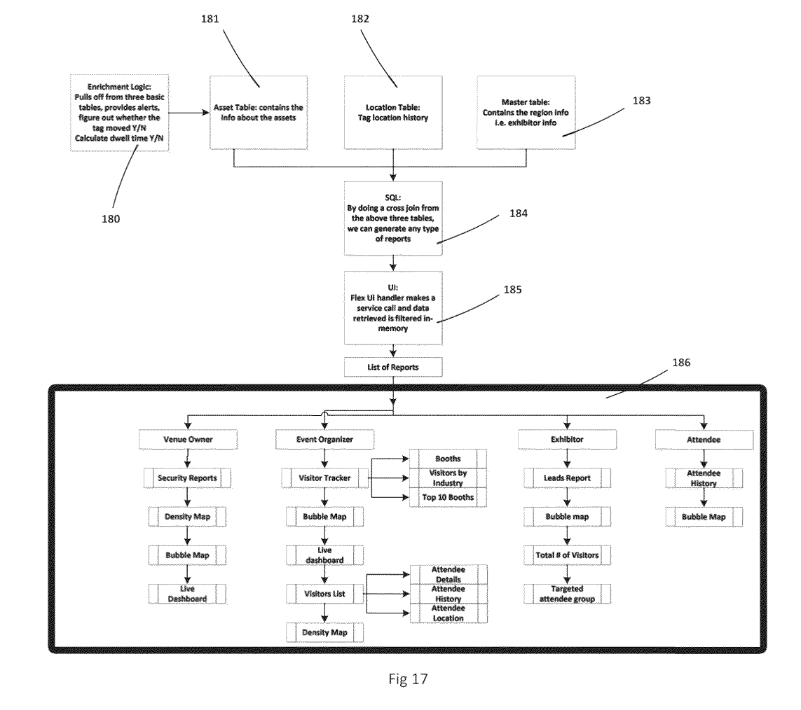

FIG. 17 illustrates the various types of reports that SmartShows™ application is able to deliver to venue owners, show organizers, meeting planners, exhibitors and attendees. Each report has its own unique requirements which are handled through the enrichment logic process (180). Data is pulled from the three primary tables; asset (181), location (182), and region (183) though commands issued through SQL (184) and returns answers in the form of reports through the Ul (185). The SmartShows™ application is capable of generating the following standard reports (186).

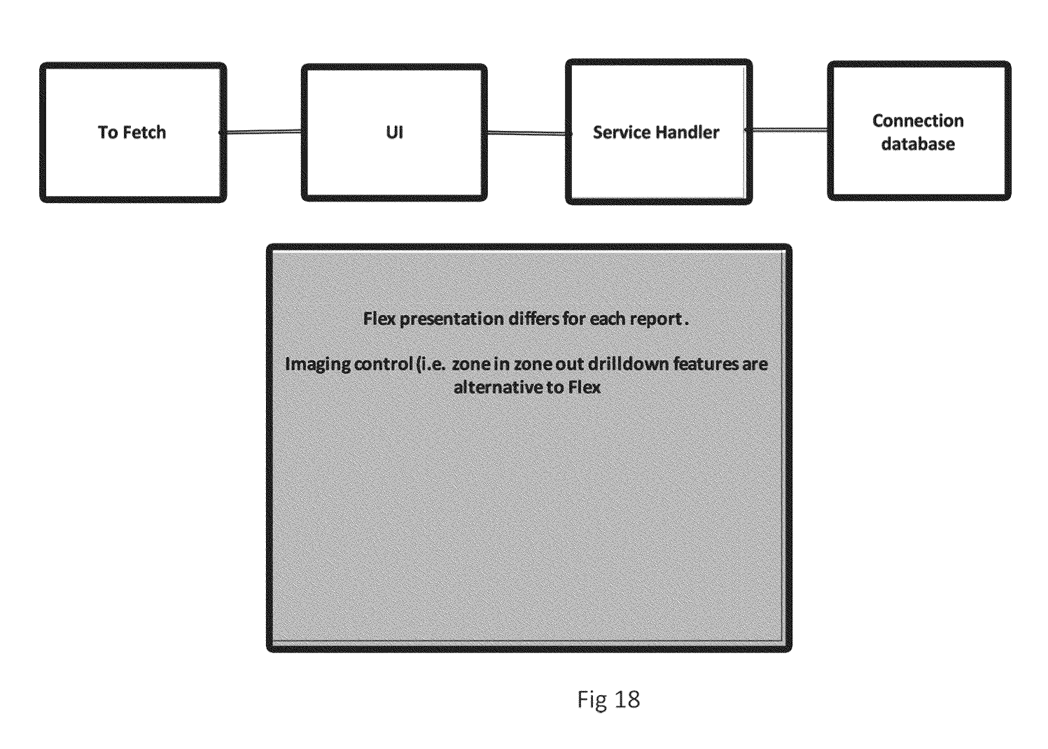

FIG. 18 illustrates how data gets persisted to the user interface (UI) of the SmartShows™ application. When a selection is made on the UI, all data persisted and processed at the UI-level is filtered in-memory. Clicking on the “Refresh” button will initiate a call back to the server. The grid-controls and the images are synchronized. When a particular booth is selected on the grid control, the associated booth image is shown on the UI. When a user clicks on a booth name, it's not initiating a server call but the command is being processed in-memory.

Through the grid controls, needed columns are defined and connections are made to source data (x). Tag reads are captured through the RTLS receivers are fed into the grid. The data grid in itself has a container for the XML that defines “what are the various columns that the system is looking at?” The data grid is tied to XML.

All the reports are the by-products of the capabilities of the application framework. The application framework has built in flex components (e.g., back-end service) that are essentially executing an SQL or calling framework data objects to retrieve data based on the selection criteria that the Ul specifies and then massages that data to present it in the right format. Using “channel builder” the user can dynamically define what the reports would be. In the channel builder, the user can build an SQL statement, save it as a report and then see the report. For every dash board, there are two components that need to be built: Flex component and Image control component. The flex Ul is uses the application frameworks built-in components to handle image control, (e.g., zoom-in, zoom-out, drill-down on regions and sub-locations) all features that are all native. to the Ul component.

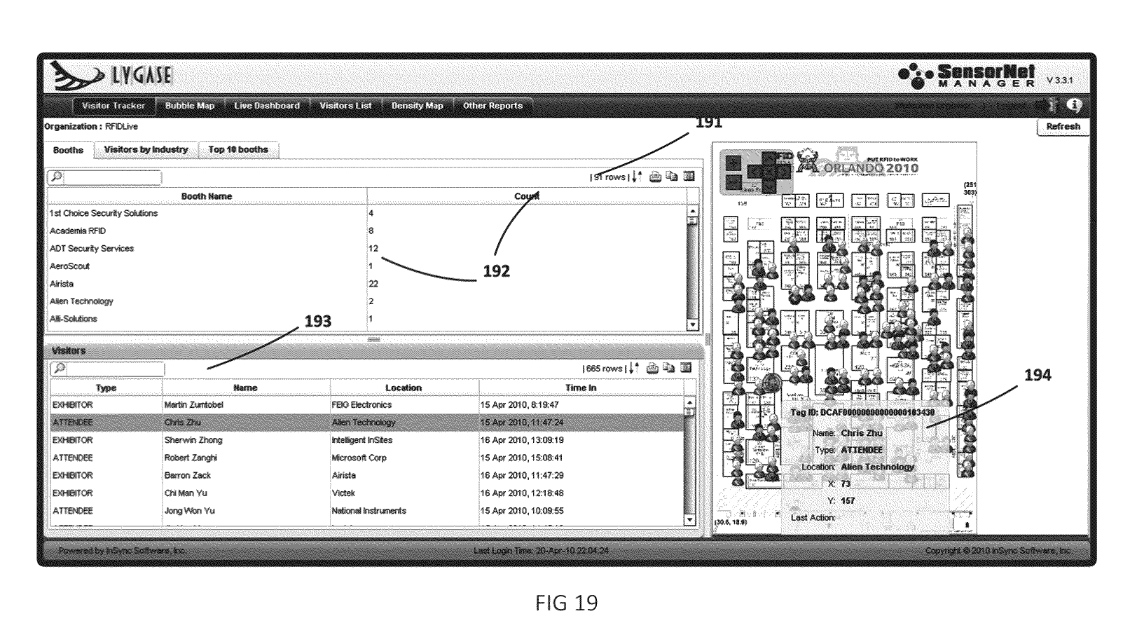

FIG. 19 illustrates the SmartShows™ Visitor tracker report that displays the total number of booths, visitors per booth and their details & location on the show floor. In one embodiment where the place of interest is the exhibit show floor, regions are defined as booths. The number of rows (191) corresponds to the total number of booths at the show and “count” column represents the number of attendees at a particular booth (192). The bottom grid represents the list of distinct visitors that match the total count seen in a particular booth or region of interest (193). Assets can be identified and seen moving on exhibit show floor in real time so when a particular attendee is selected, his location and details are displayed in a pop-up (194).

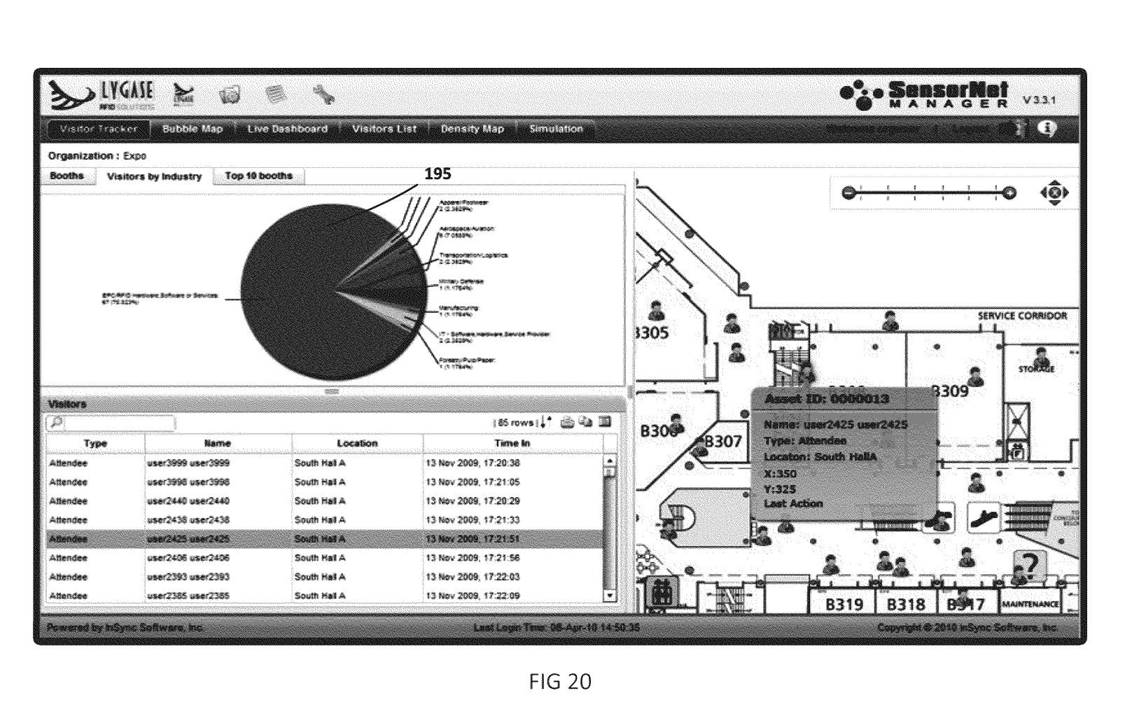

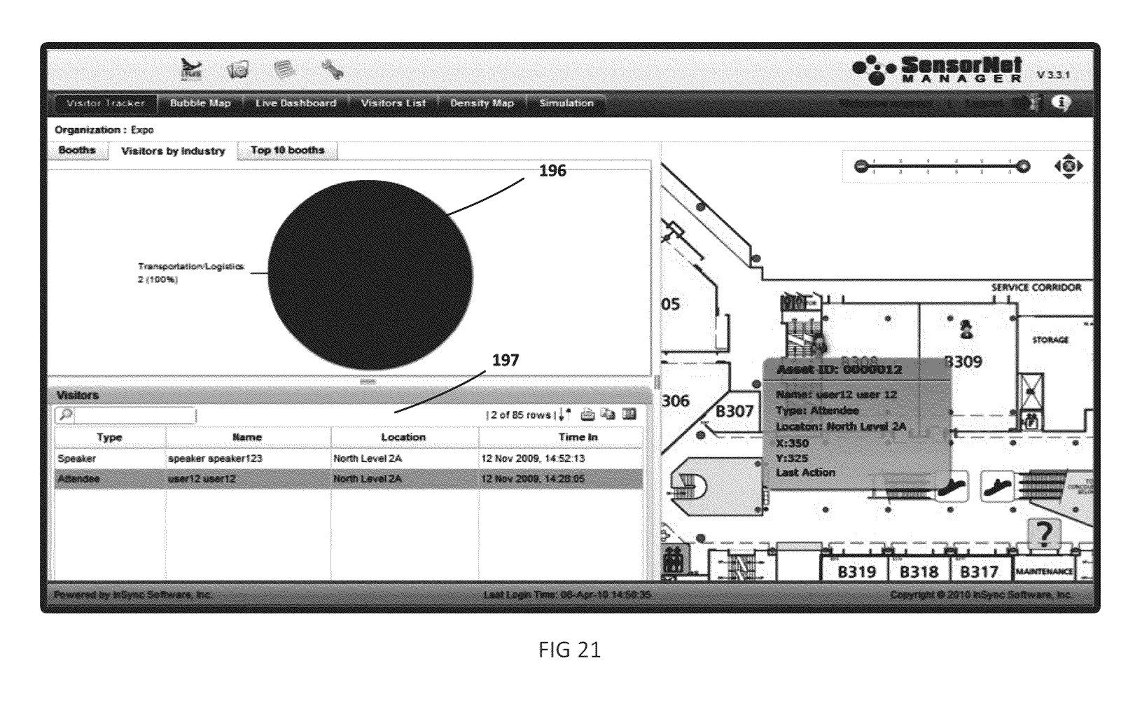

FIG. 20 illustrates the SmartShows™ Visitors by Industry report that displays a pie-chart representation of the industries that the attendees seen on floor plan belong to (195). Any selection will take user to break down of the pie as seen in FIG. 21.

FIG. 21 illustrates the breakdown of the SmartShows™ pie-chart based on the selection of a particular industry (196). SmartShows™ updates the report with the corresponding attendee list and their

location details are updated on the screen (197).

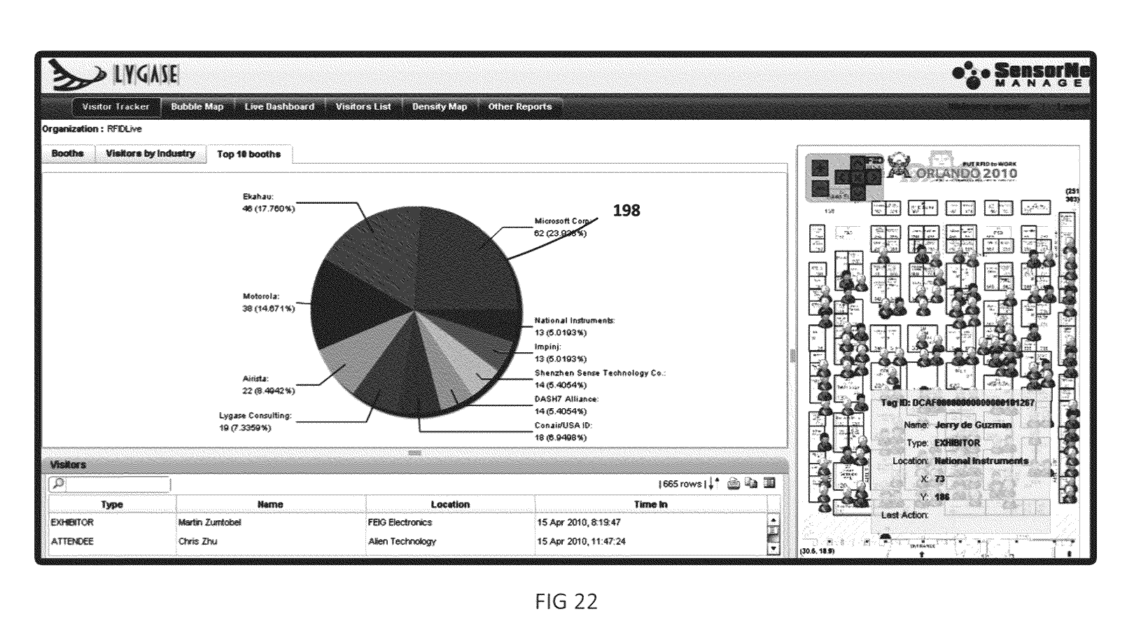

FIG. 22 illustrates the SmartShows™ Top ten booths report which is a pie-chart representation of the top

10 booths at the show based on the number of assets or attendees present (198). This can be displayed in real-time. User can select any of the booths to see the Breakdown of the Pie.

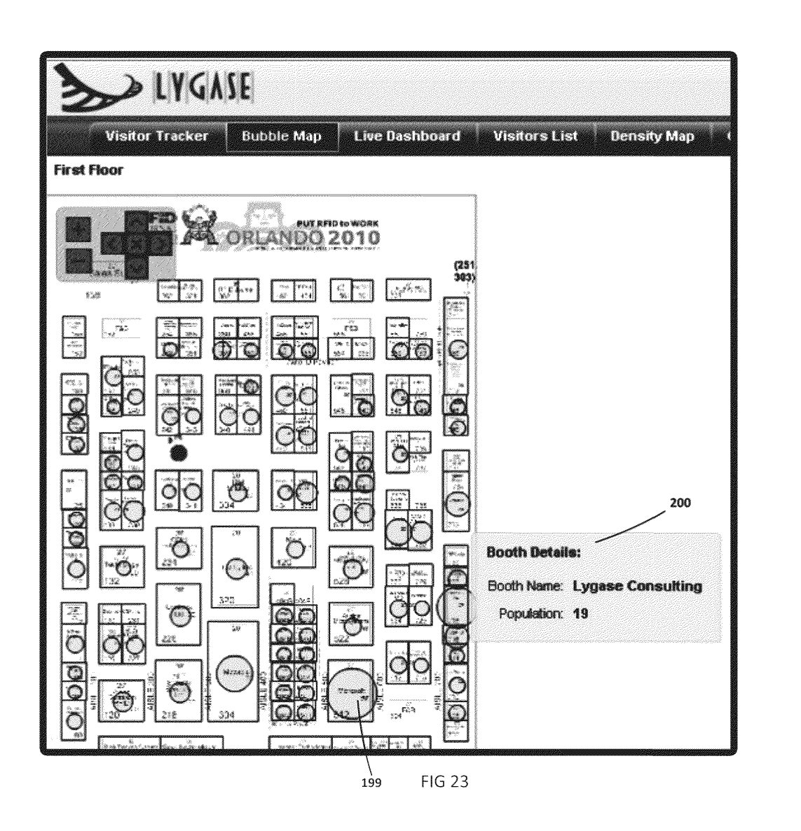

FIG. 23 illustrates the SmartShows™ real-time Bubble map report of booth population in the form of expanding and contracting bubbles (199). When a user mouse-over a bubble, a pop-up with the name and population of that particular booth is displayed (200). Assets moving throughout space of interest can be viewed in real time via the SmartShows™ report.

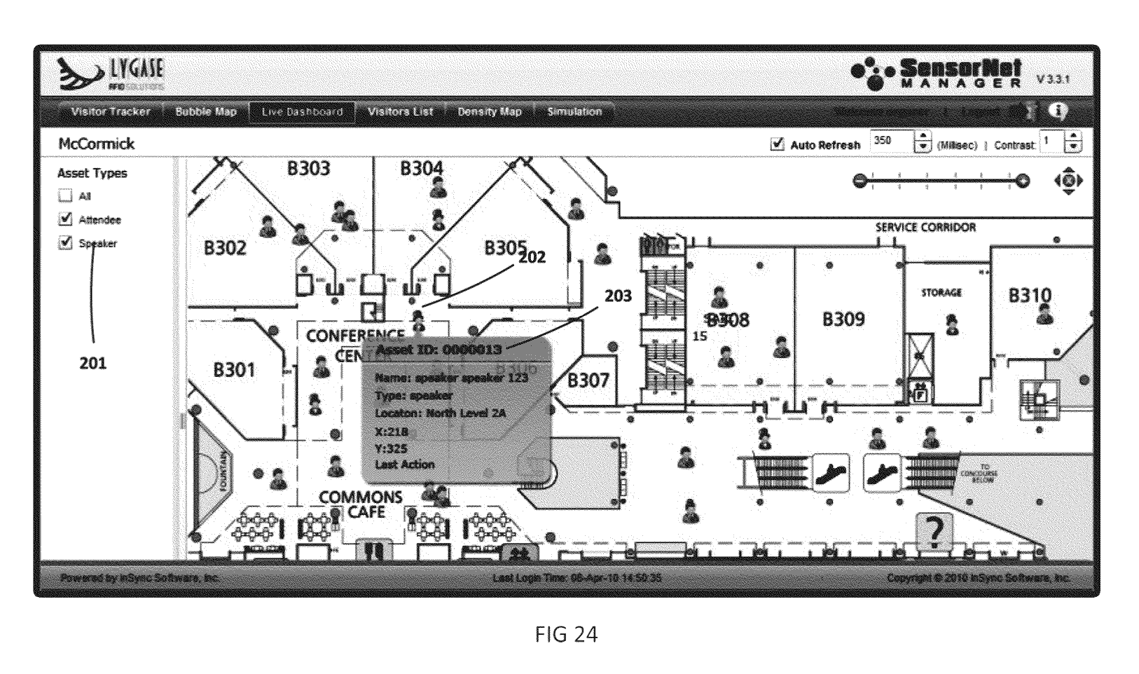

FIG. 24 illustrates a SmartShows™ Live Dashboard report that has the ability to display in real time location of a particular asset of interest based on asset type. In one embodiment where the space of interest is the trade show flow and the assets of interest are staff, exhibitors and attendees, venue owners and show organizers can view this report based on asset type. Assets are put into a category and that category defines an asset type (201). Selections can be made to display the assets location on floor plan (202). When you mouse-over an icon, a pop-up with that asset details is shown (203).

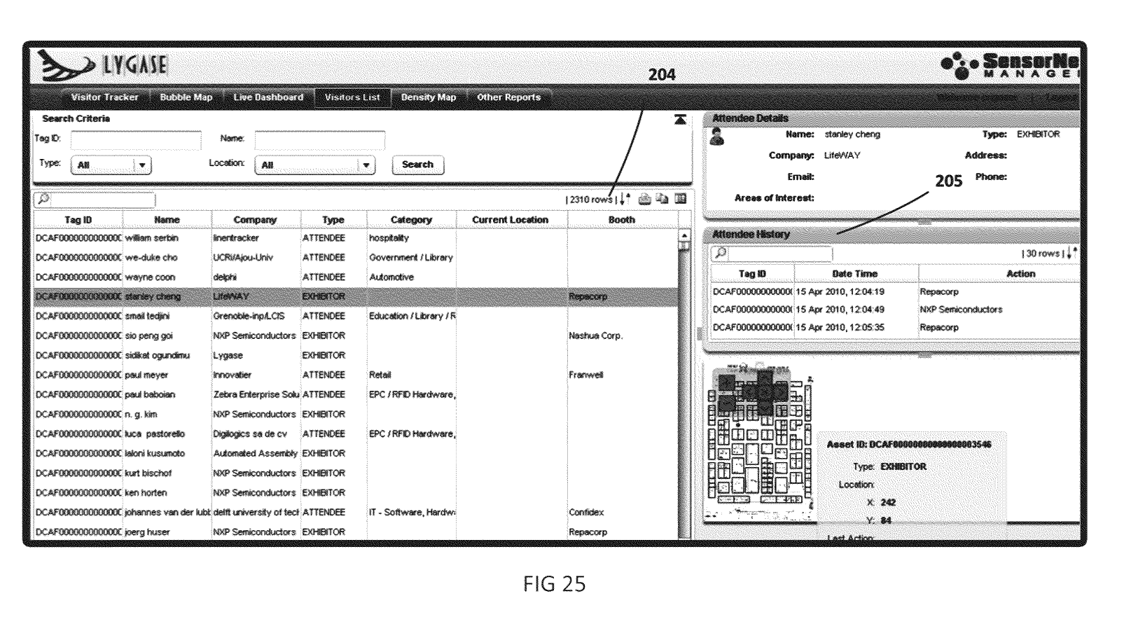

FIG. 25 illustrates the SmartShows™ Visitors List report that list of total number of assets (204) where assets are attendees and their history (205) as they moved about the space of interest. In one embodiment the space of interest is a tradeshow.

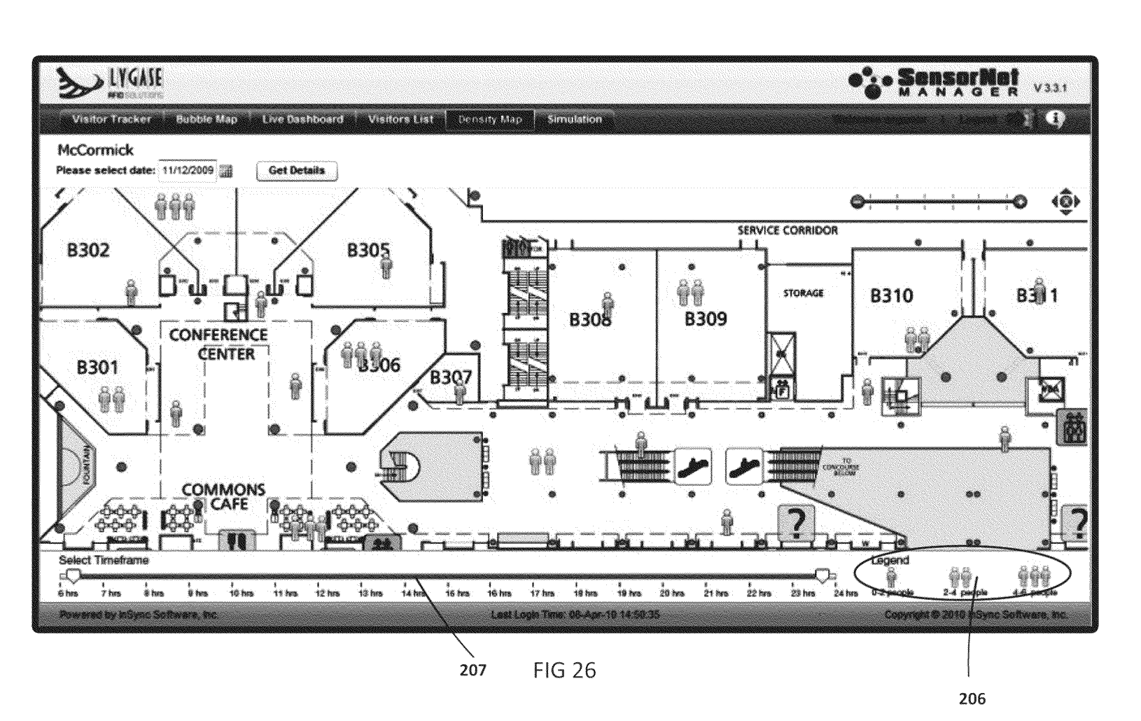

FIG. 26 illustrates the SmartShows™ Density Map which has ability to report real-time density of population at various locations across the show floor based on time. The blue, green and red icons represent the population density at that particular region on the show floor (206). The report features a time slider bar that it used to select and observe the traffic pattern during a specific time slot (207)

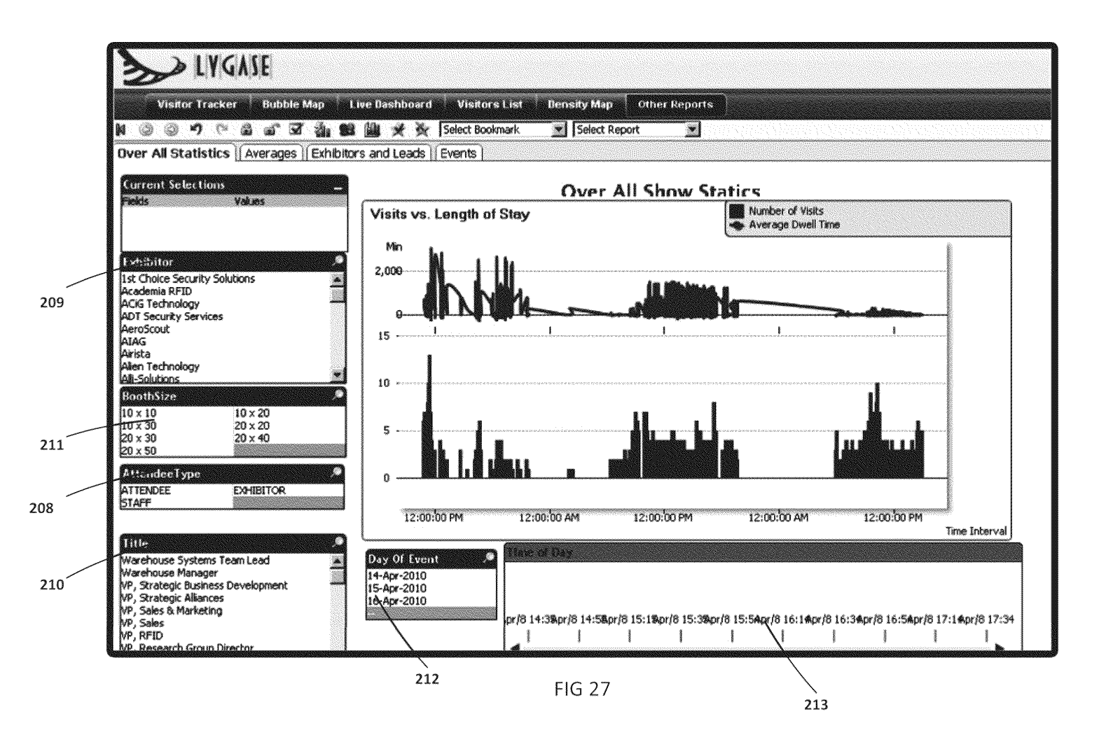

FIG. 27 illustrates SmartShows™ Overall Show Statistic reports ability to display statistics regarding asset's number of visits and average dwell time in areas of interest. Data can be sliced and diced across type of attendee (208), Exhibitor (209), Title (210), booth size (211) day of the show (212) and time of the show (213).

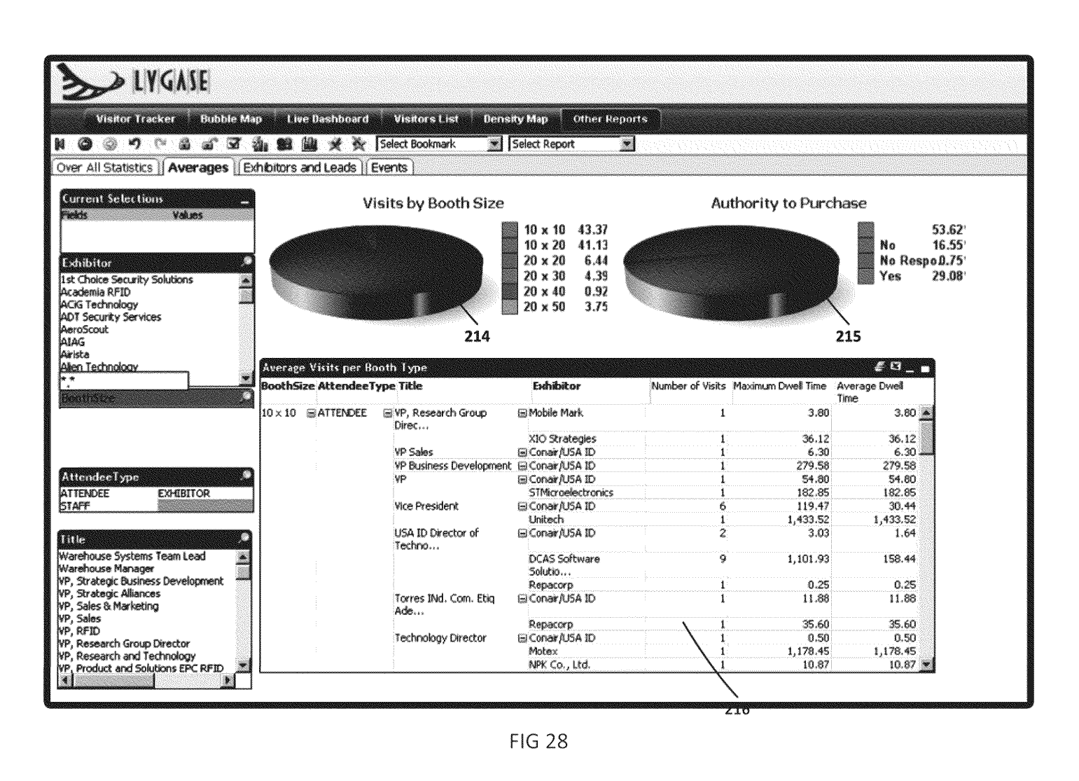

FIG. 28 illustrates SmartShows™ Averages report based on the history of tagged assets moving in space of interest. This report displays a pie chart with average visits per booth size (214) and another pie chart with the attendee's response to authority to purchase (215) and a table with the breakdown of the pie chart(216).

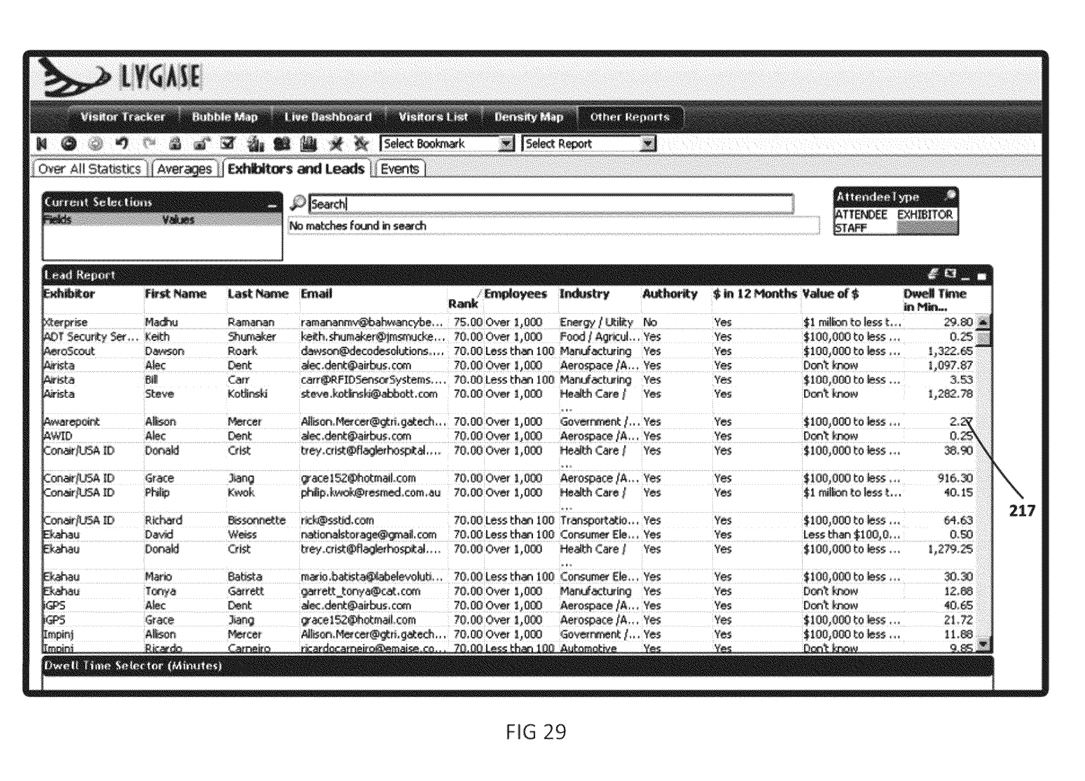

FIG. 29 illustrates SmartShows™ ability to display a report based on an attendees dwell time (217) at various locations at the Exhibit.

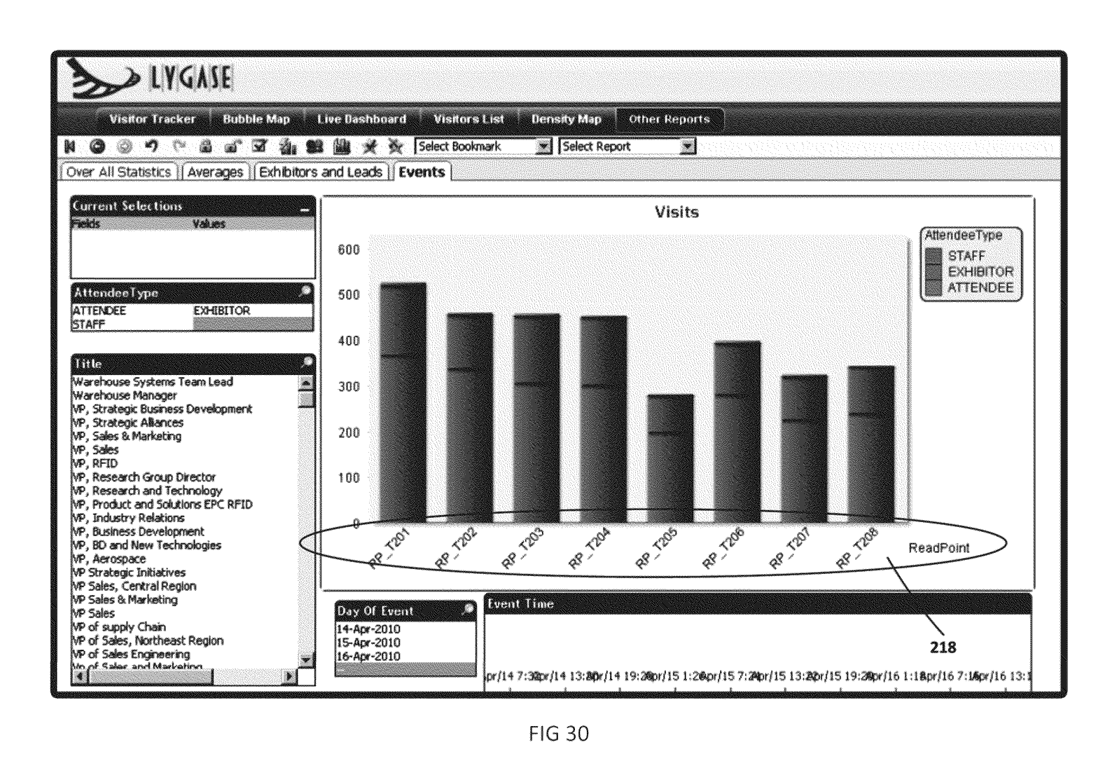

FIG. 30 illustrates SmartShows™ ability to issue continuing education units (CEU), verify attendance and calculate dwell time of attendees seen as they enter and exit meeting and conference room areas. (218).

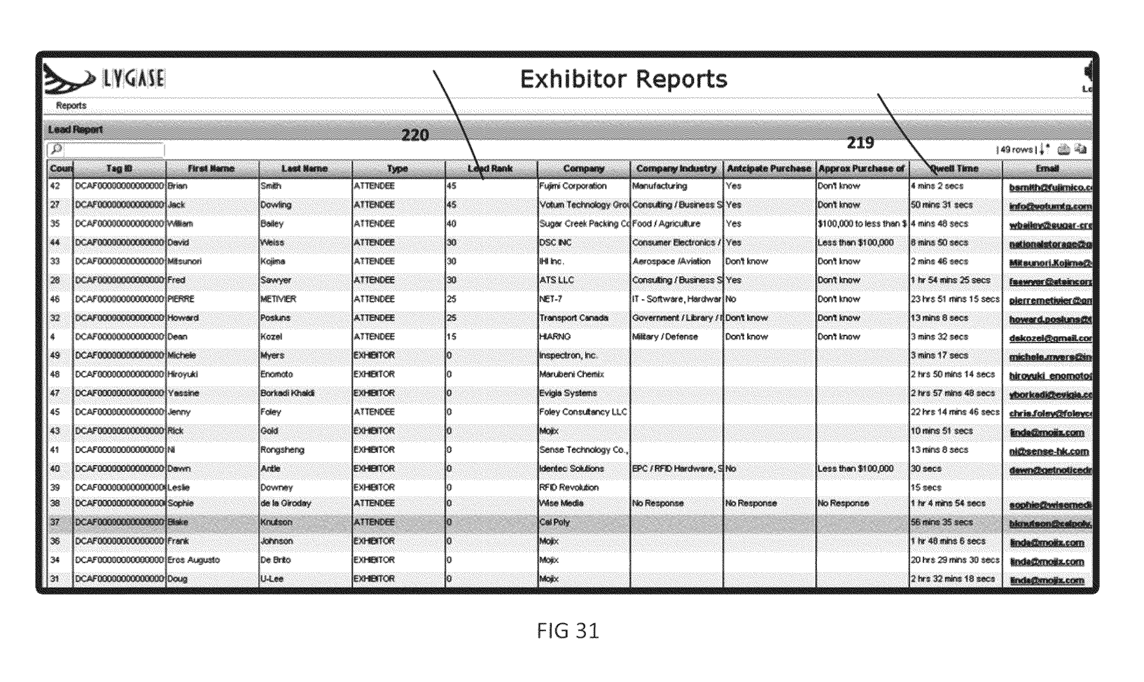

FIG. 31 illustrates SmartShows™ ability to generate an automated Leads Report which contains Lead ranking and dwell time. (219). Each record has lead ranking score that is assigned each attribute so that most qualified lead bubble to top of list (220). In one embodiment the tagged asset of interest can be attendee at tradeshow seen a particular booth

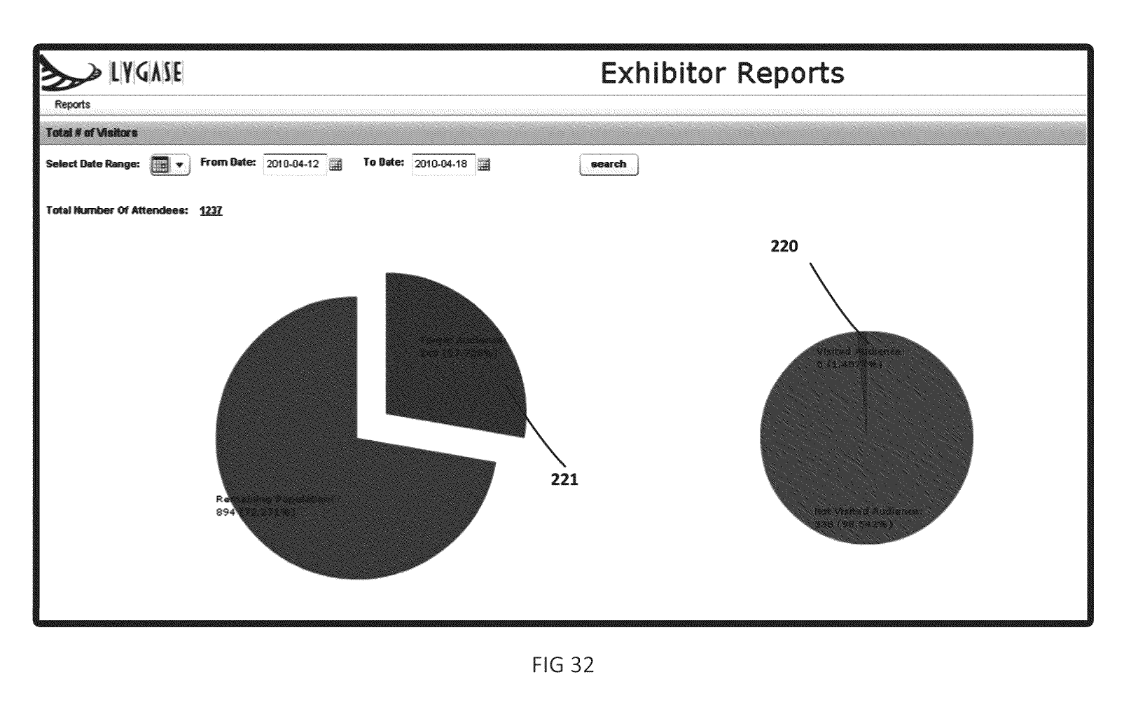

FIG. 32 illustrates SmartShows™ ability to generate the exhibitors Target Audience report out the total number of attendees seen on the exhibition show floor. In one embodiment where the assets of interest are attendees and the space of interest is the tradeshow, the number of visitors that visited the exhibitor's booth (220) is distinguished from that targeted attendee group (221).

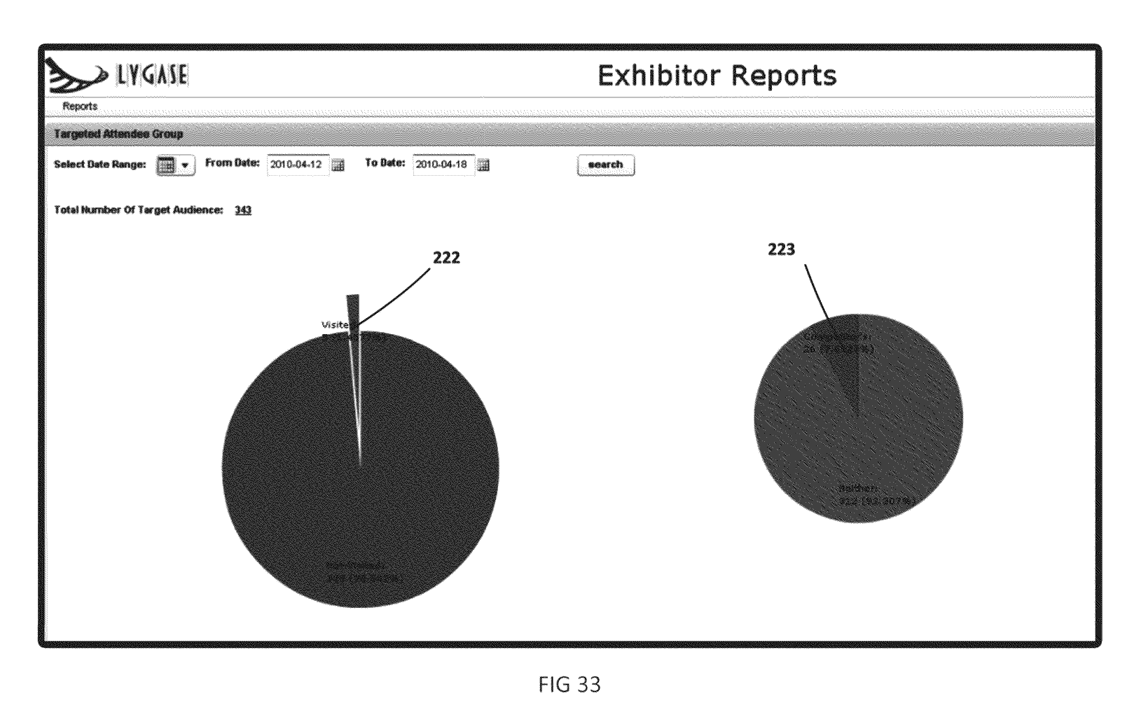

FIG. 33 illustrates SmartShows™ ability to generate a Competitive Analysis report that displays the information of those attendees that visited an exhibitor's booth (222) and also visited their competitor's booth (223).

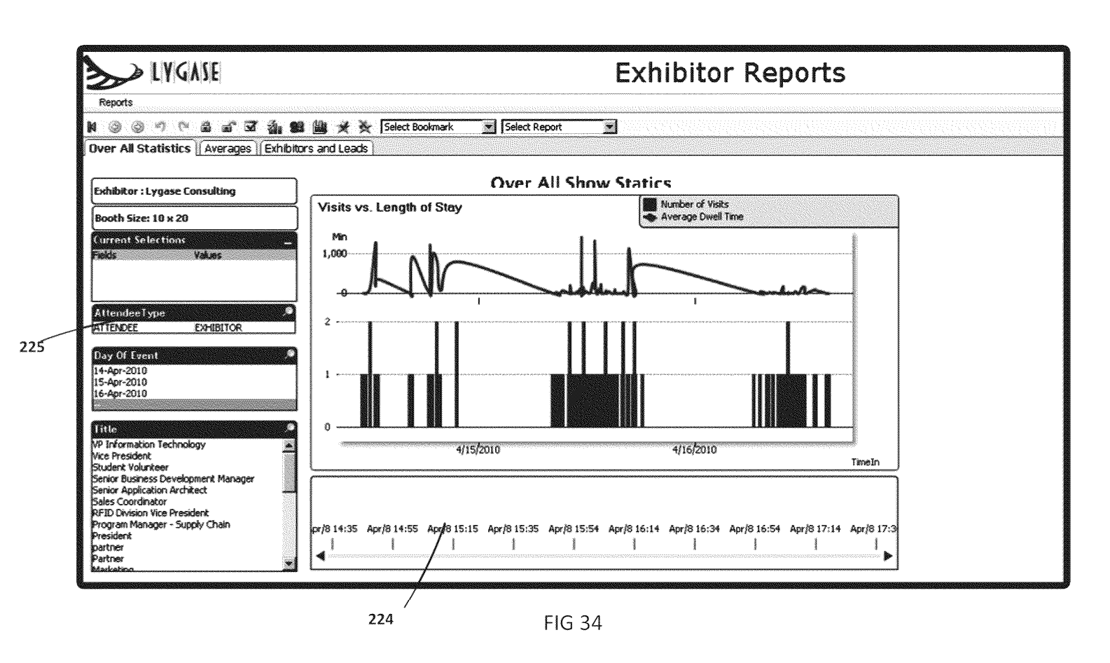

FIG. 34 illustrates SmartShows™ the ability to generate Over All Statistics report regarding asset's number of visits and average dwell time in areas of interest. Data can be sliced and diced across time and date, asset description. Data can be sliced and diced across time and date (224), asset description (225).

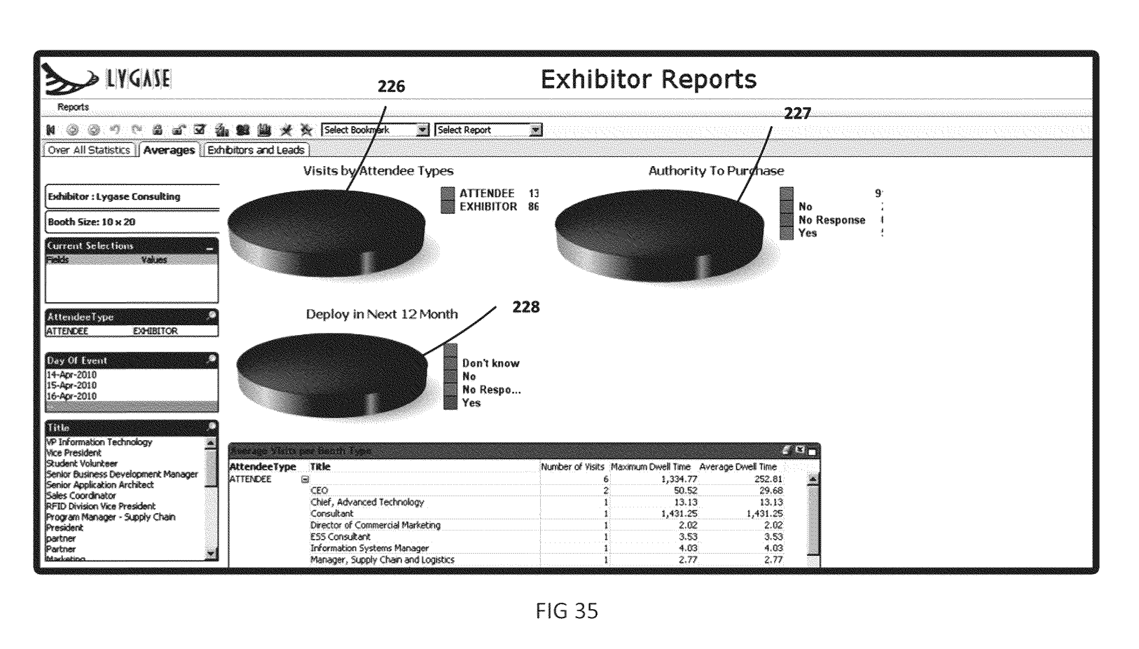

FIG. 35 illustrates SmartShows™ ability to understand traffic patterns of assets as they move around in a space of interest based on certain criteria. Patterns of behavior are gleaned from looking at average/maximum dwell time, and number of visits to space of interest (226). In one embodiment where assets of interest are tradeshow attendees and exhibitors the report could determine which assets had the authority to make purchasing decisions (227), who could make purchases in the next 12 months (228).

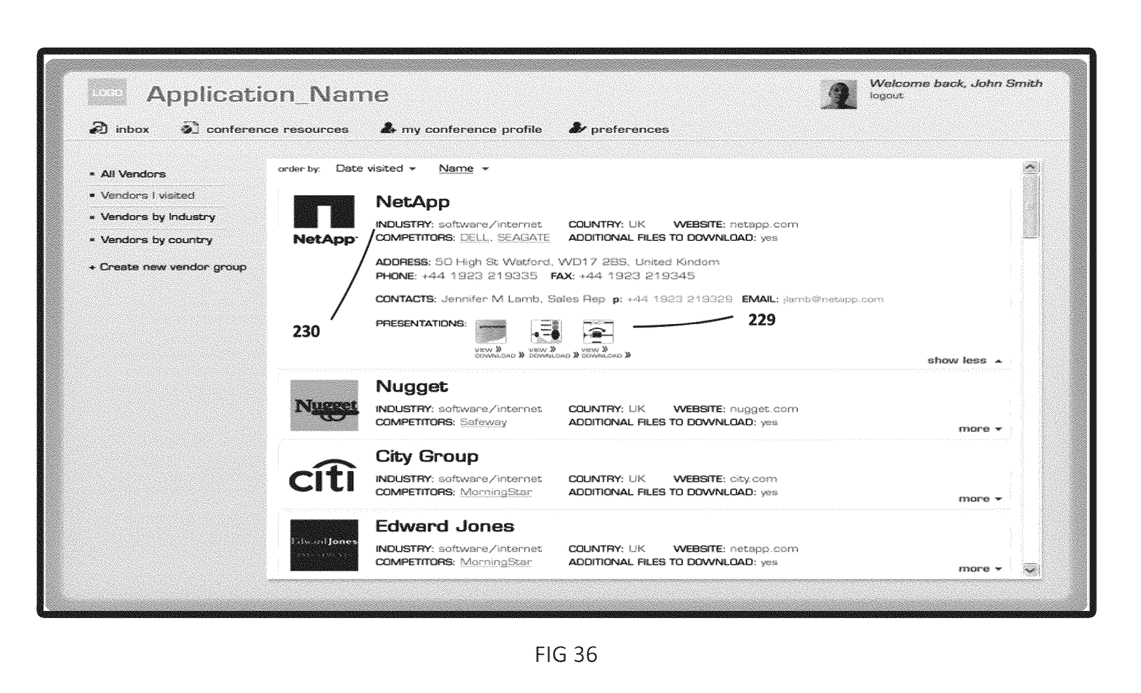

FIG. 36 illustrates the ability to provide user a web interface that contains marketing material from all regions or booths that a tagged asset was seen from which a user can download (229). This display can report information pertaining to competitors that users can become familiar (230).

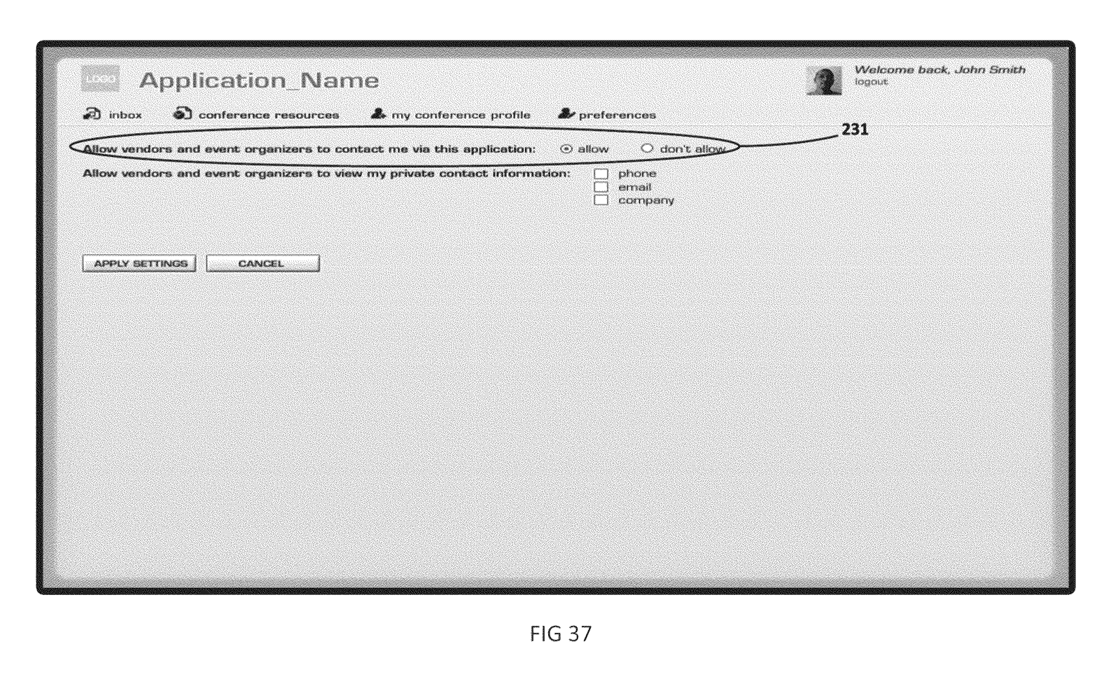

FIG. 37 Illustrates the Attendee's ability to opt-in or opt-out of the automated lead retrieval system (231).

In sum, a system and method are provided, the system being a business intelligence system that captures data in real time and allows for historical and analytical reporting. The SmartShows™ solution relies on passive UHFsensor technology and passive UHF tags that capture pin point location of a particular asset (i.e. person or object) and based upon knowledge of that asset's location the application is designed to provide meaningful reports related to actual movement and activity. The system is comprised of various components that are beneficial in order for the Lygase SmartShows™ application to produce reports. The system relies on hardware components such as tags and sensor related technology that communicates and passes data to the application framework that handles data, stores data captured from sensors as events in database and Lygase using algorithms, business rules and sql to generate meaningful real time reports.

In this system the reports are driven by time. In one embodiment an asset remains in a region of interest for a determined amount of time, and a report is generated to allows end-users to understand behavioral patterns. In another embodiment, the asset may be a person attending a tradeshow exhibition, the region of interest an exhibitor booth, and a determination may be made that the person attending the tradeshow exhibition has shown interest in the products or services offered by the exhibitor. Similarly, if two or more assets are determined to have been located at the same location or within close proximity of each other for a determined amount of time then a inferences can be made that these assets have interacted with each other. As an example a first asset of interest can be a sales person exhibiting their company's product and services on tradeshow floor, a second asset of interest can be a person attending the tradeshow exhibition, and a determination may be made that the sales person has interacted with the person attending the tradeshow exhibition.

In one embodiment this system is designed to help business owners who have the need to manage tradeshow information along with location information obtained from tradeshow attendees. In this embodiment, the assets of interest are tradeshow attendees and exhibitor personnel working in tradeshow booths (collectively “attendees”). Attendee data is collected during a registration process where a tag ID is associated with an attendee record that is stored in any database form including XML databases, relational databases, or any other memory storage device. The tag is then given to the attendee so that as they move from booth to booth the Smartshows™ system is able to record the actual location of the attendee. The SmartShows™ system is capable of generating lead capture reports, targeted advertisement, competitive analysis reports, targeted survey, density reports and lead ranking reports.

The SmartShows™ system is designed to help tradeshow attendees review reports about his or her locations at the conference, such as regions or booths attended at the tradeshow or conferences. The information reported indicates how long an asset spent in a particular region. The web hosted solution of this system supports a dynamically generated web portal per person that moves around a space of interest. In this way users can login to web site to review history of movements on tradeshow floor and conference areas and review marketing material from each vendor. Marketing programs or special offers are provided exclusively over the website where access is restricted to registered users. Post marketing efforts are now supported thru target surveys, suggested booths on floor plan that can be delivered via mobile devices, Marketing collateral can now be obtained based booths visited thus making SmartShows™ a true value added green solution.

Lygase RFID Solutions develops business intelligence (BI) applications that use real time locating systems (RTLS) and sensor-based technologies to help clients improve operational efficiencies and enhance target marketing strategies. Lygase's proprietary data capturing technology and intellectual property drives the company's Smart brand of BI applications, which increase efficiencies and maximize profitability through the intelligence found in data. Lygase differentiates itself from its competition by capturing and delivering meaningful data, providing customized dashboards and tools necessary to derive actionable value from this information. The ability to digitize floor plans and observe traffic in real time helps venue owners and show organizers maximize valuable floor space and product organization, improves profitability and ROI. Also, SmartShows™ offers accurate, dynamic and rich demographic data for all stakeholders that enables new direct-to-consumer marketing opportunities that are not available in the prior art. The SmartShows™ systems and methods described provide insights, patterns and conclusions that provide customizable and automated marketing opportunities to each stake hold holder that could not otherwise be possible. SmartShows™ offers quantifiable data and delivers value across all four trade show stakeholders: venues, event organizers, exhibitors and attendees. Stakeholder value propositions include: Increased security and tracking of employees, contractors, goods and attendees; SmartShows™ System Allows for the Display in Real Time Locations of Assets of interest in a space of interest; SmartShows™ provides solution for automated attendance tracking and CEU credits using fixed point traditional readers; SmartShows™ uses pre-determined physical attributes regarding assets for the purpose of understanding behavior of objects moving within digitized floor plan; SmartShows™ application generates a lead report containing dwell time and ranking score of asset of interest in space of interest; SmartShows™ applications can leverage data to understand the persons product interest in order to create and deliver personalized messages while moving around in space of interest; SmartShows™ delivers personalized dashboards containing marketing collateral for attendees designed to enhance the show experience; SmartShows™ application can analyze any particular assets pattern of behavior.

Trade shows have previously relied heavily on a mix of bar code scanning, registration data and personal observation to study key metrics. Typically, exhibitors at trade shows have measured success in terms of the number of qualified leads obtained during the show. With the availability of SmartShows™ exhibitors may now challenge show organizers when the perceived quality of attendees does not meet expectations. Trade show organizers rely on overall attendance data collected at registration during such conversations, but with current technology it cannot be proven, for example, that an exhibitor's staff was insufficient to engage attendees in their booth during peak show times, or that a larger or more strategically placed booth location would generate more qualified leads.

The system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those skilled in this art without departing from the spirit and scope of the present invention.

What is claimed is:

1. A method for capturing and analyzing real-time event data, comprising:
providing a unique identification to a person or object associated with an event;
capturing location data of a person or object a plurality of times during the event based on an automated detection of the unique identification;
storing the captured data in a database in real time;
processing the stored data using a processor of a computer;
preparing reports based on the stored real-time data; and
presenting the prepared reports to a user.
